(19) United States
(12) Patent Application Publication
(10) Pub. No.: US 2025/0177963 A1
(43) Pub. Date: Jun. 5, 2025

(54) METHODS AND COMPOSITIONS FOR CHEMICAL LOOPING AMMONIA SYNTHESIS AT LOW PRESSURE

(71) Applicant: West Virginia University Board of Governors on Behalf of West Virginia University, Morgantown, WV (US)

(72) Inventors: Jianli Hu, Morgantown, VA (US); Siobhan W. Brown, Morgantown, VA (US); Sarojini Tiwari, Morgantown, VA (US); Yuxin Wang, Morgantown, VA (US); Brandon Robinson, Morgantown, VA (US)

(21) Appl. No.: 18/840,781

(22) PCT Filed: Feb. 24, 2023
(86) PCT No.: PCT/US2023/013868

§ 371 Date: Aug. 22, 2024

Related U.S. Application Data
(60) Provisional application No. 63/358,516, filed on Jul. 5, 2022.
(60) Provisional application No. 63/313,672, filed on Feb. 24, 2022.

(51) Int. Cl. B01J 23/882; B01J 27/24; B01J 37/08; B01J 37/34; C01C 1/04

(52) U.S. Cl. CPC B01J 23/882; B01J 27/24; B01J 37/08; B01J 37/346; C01C 1/0411

(57) ABSTRACT

In accordance with the purpose(s) of the present disclosure, as embodied and broadly described herein, the disclosure, in one aspect, relates to a chemical looping process for ammonia synthesis at low pressure. In various aspects, the present disclosure relates to compositions useful for chemical looping ammonia synthesis, methods of making same, methods of using the disclosed compositions to activate and store nitrogen in a catalyst composition at low pressure, and methods of utilizing the activated and stored nitrogen for production of ammonia at low temperature. This abstract is intended as a scanning tool for purposes of searching in the particular art and is not intended to be limiting of the present disclosure.

### CROSS-REFERENCE TO RELATED APPLICATIONS

The present application claims the benefit of U.S. Provisional Application No. 63/313,672, filed Feb. 24, 2022, and U.S. Provisional Application No. 63/358,516, filed Jul. 5, 2022, both of which are incorporated by reference in their entireties and relied upon.

### BACKGROUND

Ammonia has become one of the most industrially important synthetic chemicals (G. V. Duinen, Nat. Geosci., 2008, 1, 4). For example, ammonia, which contains 82 percent nitrogen, is the main source for nitrogen in various types of fertilizers used in crop production used globally. In the chemical industry, ammonia is conventionally produced in large-scale plants via the Haber-Bosch (H-B) process. The industrial H-B process is a technology that consumes considerable energy-requiring high temperature (400-570° C.), high pressure (150-250 bar, or about 148-246 atm) and an effective catalyst (Fe promoted with K₂O and Al₂O₃ as well as other metal oxides). Moreover, current ammonia plants are very large, e.g., producing 1000 ton/day ammonia.

It is estimated that current ammonia production, together with upstream Ha production from steam reforming or coal gasification process consumes approximately 2% of world power generation. Importantly, 1.87 tons of CO₂ is released per ton of ammonia produced. In 2010, 245 million tons of CO₂ was released as a result of ammonia production, which is equivalent to 0.77% of the world total CO₂ emissions. The chemical industry has been trying to optimize the H-B process to decrease the amount capital and energy required. Although optimization of process conditions and catalysts have resulted in about 30% efficiency improvements, the H-B the process still accounts for 1-2% of global energy consumption (P. H. Pfromm, J Renew. Sustain. Energy, 2017, 12; and M. Appl, in Ullmann's Encyclopedia of Industrial Chemistry, Wiley-VCH Verlag Gmbh & Co. KGaA, Weinheim, 2006).

Industry has also attempted to scale down the H-B process, for example, in order to take advantage of renewable energy resources. The current H-B synthesis of ammonia is too large for the deployable scale of renewables (ranging from 1-2 MW to 100-150 MW). If the conventional H-B process could be scaled down to about 100 ton/day, this would reduce the energy consumption to about 150 MW of renewable energy. At an energy consumption of about 150 MW, the energy requirement matches well with a single mid-size solar/wind farm or combination of several renewable sources. However, scaling the H-B process down to about 100 ton/day increases the production cost by a factor of 2 to 3.

Other industrial efforts to synthesize ammonia without the H-B approach, including electrochemical, biomimetic routes, and novel chemical looping processes, are all at the fundamental research level at this time. As reported, electrochemical approaches often yield only trace amounts of ammonia at modest current efficiencies, while biomimetic routes suffer from the requirement for liquid phase operation with slow mass transfer, often slow kinetics, and sometimes requirements for co-factors that are prohibitively expensive and/or complex to provide.

Moreover, commercial ammonia synthesis under current environmental, climate, and economic requirements would be greatly enhanced by systems that operate at less extreme reaction conditions, e.g., lower pressure and/or temperature, use less expensive or toxic catalytic materials, has an improved safety profile, and can provide intermittent or deferred production, e.g., allow activation and storage of nitrogen for use when hydrogen gas can be provided and energy is least expensive in a daily cycle.

Accordingly, despite advances in the improving the efficiency of the H-B process and ammonia synthesis without the H-B process, there is still a need for an industrial ammonia synthesis process with improved energy efficiency, allows efficient pairing with renewable energy resources, reduced capital and operating costs. These needs and other needs are satisfied by the present disclosure.

### SUMMARY

In accordance with the purpose(s) of the present disclosure, as embodied and broadly described herein, the disclosure, in one aspect, relates to a chemical looping process for ammonia synthesis at low pressure. In various aspects, the present disclosure relates to compositions useful for chemical looping ammonia synthesis, methods of making same, methods of using the disclosed compositions to activate and store nitrogen in a catalyst composition at low pressure, and methods of utilizing the activated and stored nitrogen for production of ammonia at low temperature.

Disclosed herein are methods for synthesis of a nitrided catalyst composition, the method comprising: providing a reaction chamber; providing a catalyst composition in the reaction chamber; flowing a reactant gas into the reaction chamber and over the catalyst composition; wherein the reactant gas in contact with the catalyst composition forms a reaction composition; wherein the reactant gas comprises nitrogen; heating the reaction chamber; wherein the heating is carried out at a nitridation reaction pressure of from about 0.5 atm to about 5 atm; thereby synthesizing the nitrided catalyst composition.

Also disclosed herein are methods for synthesis of ammonia, the method comprising: providing a reaction chamber; providing a disclosed nitrided catalyst composition; flowing a reactant gas into the reaction chamber and over a catalyst composition; wherein the reactant gas comprises hydrogen; wherein reactant gas in contact with the catalyst composition forms an ammonia reaction composition; heating the reaction chamber; thereby synthesizing ammonia.

Also disclosed herein are methods for synthesis of ammonia, the method comprising: providing a reaction chamber; providing a catalyst composition in the reaction chamber; flowing a first reactant gas into the reaction chamber and over the catalyst composition; wherein the reactant gas in contact with the catalyst composition forms a reaction composition; wherein the reactant gas comprises nitrogen; heating the reaction chamber in a first heat step; wherein the heating is carried out at a nitridation reaction pressure of from about 0.5 atm to about 5 atm; thereby synthesizing a nitrided catalyst composition; purging the reaction chamber with a gas; flowing a second reactant gas into the reaction chamber and over the nitrided catalyst composition; wherein the reactant gas comprises hydrogen; and wherein the reactant gas in contact with the catalyst composition forms an ammonia reaction composition; heating the reaction chamber in a second heating step; thereby synthesizing ammonia.

A nitrided catalyst composition.

A nitrided catalyst composition prepared by a disclosed method.

Ammonia synthesized by a disclosed method.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

Many aspects of the present disclosure can be better understood with reference to the drawings disclosed in the accompanying appendices. The components in these drawings are not necessarily to scale, emphasis instead being placed upon clearly illustrating the principles of the present disclosure. Moreover, in the drawings, like reference numerals designate corresponding parts throughout the several views.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1B show a representative diagram of the nitridation processes of the present disclosure. Without wishing to be bound by a particular theory, FIG. 1A shows microwave irradiation is absorbed by metal particles that results in volumetric heating in both metal particles and SiC, e.g., heat conducted from SIC particles to metal particles and electrons are pushed to the surface where they can activate neutral molecules, e.g., N₂. Further, without wishing to be bound by a particular theory, FIG. 1B shows that as metal particles are nitrided, they become more electrically insulating and the heating process requires more energy to heat volumetrically and by conduction from SIC.

FIG. 2 shows a representative schematic of a representative microwave of the present disclosure comprising a generator, waveguide, sliding short, 4-stub autotuner, IR pyrometer, mass flow controllers, and online gas phase FTIR analyzer.

FIGS. 3A-3B show representative diagrams of a Chemical Looping Ammonia Synthesis (CLAS) performance comparison between microwave and thermal heating. FIG. 3A shows a representative diagram of a disclosed CLAS process. In diagram, initiation steps comprise reduction of the oxide precursors followed by nitridation to the active phase, hydrogenation to form ammonia, and the eventual deactivation leading to the formation of multiple stable inactive phases, which can break the cycle. FIG. 3B shows an alternative representative diagram of a disclosed CLAS process showing discretely three ammonia synthesis cycles. As shown in this diagram, the ammonia synthesis reaction, or hydrogenation step, as disclosed herein can comprise three nitridation cycles with a system purge comprising an inert gas between each cycle. In various aspects of the present disclosure, CoMoO₄ can be pre-reduced before nitridation.

FIGS. 4A-4F show representative data for time on stream experiments for Fe and CoMo systems for three CLAS cycles, comparing continuous flow conventional thermal fixed bed (CTFB) and a continuous flow microwave fixed bed (MWFB) under identical reaction conditions. The studies were carried out at 450° C. for 15 minutes under hydrogen flow. FIGS. 4A-4C show representative in which the reaction system comprise iron particles, whereas FIGS. 4D-4F comprised CoMo as disclosed herein. The lines showing comparison between CTFB and MWFB are as indicated in the figure. FIG. 4A shows representative experimental data for a CTFB reaction for CLAS cycle #1 carried out in a reaction system comprising Fe particles where the reaction was conducted at 450° C. for 15 minutes under hydrogen flow. FIG. 4B shows representative experimental data for a CTFB reaction for CLAS cycle #2 carried out in a reaction system comprising Fe particles where the reaction was conducted at 450° C. for 15 minutes under hydrogen flow. FIG. 4C shows representative experimental data for a CTFB reaction for CLAS cycle #3 carried out in a reaction system comprising Fe particles where the reaction was conducted at 450° C. for 15 minutes under hydrogen flow. FIG. 4D shows representative experimental data for a CTFB reaction for CLAS cycle #1 carried out in a reaction system comprising CoMo where the reaction was conducted at 450° C. for 15 minutes under hydrogen flow. FIG. 4E shows representative experimental data for a CTFB reaction for CLAS cycle #2 carried out in a reaction system comprising CoMo where the reaction was conducted at 450° C. for 15 minutes under hydrogen flow. FIG. 4F shows representative experimental data for a CTFB reaction for CLAS cycle #3 carried out in a reaction system comprising CoMo where the reaction was conducted at 450° C. for 15 minutes under hydrogen flow.

FIGS. 5A-5B show representative temperature distribution data for a disclosed process carried out under MWFB conditions comprising both N₂ and H₂ flow at 50 mL/min, as acquired by thermal imaging. The data were obtained from the thermal images, as described herein below, that were recorded during the nitridation and the hydrogenation step of the cyclic reactions. FIG. 5A shows a representative temperature distribution for a CoMo:SiC system where the set point was 750° C. and 450° C. respectively. FIG. 5B shows a representative temperature distribution for a Fe:SiC system where the set point is 450° C.

FIGS. 6A-6F show representative scanning electron micrographs showing representative morphology of representative disclosed reaction materials. Each micrograph image the scale is shown in the lower right of the image. FIG. 6A shows a representative scanning electron micrograph of fresh Fe powder. FIG. 6B shows a representative scanning electron micrograph of fresh Fe powder. FIG. 6C shows a representative scanning electron micrograph of nitrided Fe powder after CTFB for 1 h at 450° C., 50 mL/min. FIG. 6D shows a representative scanning electron micrograph of nitrided Fe powder after CTFB for 1 h at 450° C., 50 mL/min. FIG. 6E shows a representative scanning electron micrograph of a reaction materials after MWFB for three-cycles using Fe 1:1 physically mixed with SIC. FIG. 6F shows a representative scanning electron micrograph of a reaction materials after MWFB for three-cycles using Fe 1:1 physically mixed with SIC. The images indicate that the CTFB Fe powder had little morphological changes occurring between the fresh Fe powder and nitrided Fe powder (compare FIGS. 6A-6D). Moreover, the images show that spent Fe MWFB after three CLAS cycles (see FIGS. 6E-6F) show slight evidence of agglomeration, with FIG. 6F showing the somewhat greater agglomeration.

FIGS. 7A-7F show representative scanning electron micrographs showing representative morphology of representative disclosed reaction materials. Each micrograph image the scale is shown in the lower right of the image. FIG. 7A shows a representative scanning electron micrograph of fresh CoMoO₄ powder. FIG. 7B shows a representative scanning electron micrograph of fresh CoMoO₄ powder. FIG. 7C shows a representative scanning electron micrograph of CoMoO₄ powder after 3 h 750° C. reduction process under 50 mLmin⁻¹ H₂. FIG. 7D shows a representative scanning electron micrograph of CoMoO₄ powder after 3 h 750° C. reduction process under 50 mLmin⁻¹ H₂. FIG. 7E shows a representative scanning electron micrograph of a reaction materials comprising nitrided CoMo after both 3 h 750° C. reduction process under 50 mLmin⁻¹ H₂ followed by 1 h 750° C. nitridation process under 50 mLmin⁻¹ of N₂. FIG. 7F shows a representative scanning electron micrograph of a reaction materials comprising spent CoMo after both 3 h 750° C. reduction process under 50 mLmin⁻¹ H₂ followed by 1 h 750° C. nitridation process under 50 mLmin⁻¹ of N₂.

FIGS. 8A-8B show representative scanning electron micrographs showing representative morphology of representative disclosed reaction materials. Each micrograph image the scale is shown in the lower right of the image. Each of FIG. 8A and FIG. 8B shows a representative scanning electron micrograph of spent particles of CoMo:SiC after three cycles of MWFB carried out at 750° C. 1 h 750° C. nitridation process under 50 mLmin⁻¹ of N₂. 1 h 750° C. nitridation process under 50 mLmin⁻¹ of N₂ followed by 1 h 450° C. hydrogenation process under 50 mLmin⁻¹ of H₂.

FIGS. 9A-9B show representative CoMoO₄ X-ray diffraction patterns of representative reaction materials after reaction under CLAS conditions. FIG. 9A shows a series of panels for CoMo oxide species as labeled therein, whereas FIG. 9B shows a series of panels for spent and nitrided CoMo oxide species as labeled therein. The structure characterization of the CoMo CLAS candidate was performed with XRD for each step of the reaction cycle; pre-reduction, nitridation, and spent samples. The data in FIG. 9A indicate that reduction and calcination processes likely do not remove all complexed water, or rather, result in a mixed-phase product finally resulting in a partially reduced system. The 3 h reduced CoMo system does not resemble CoMo metal alloy, nor the oxide precursor, so there may be a further intermediate collection of phases. The “intermediate” is a suboxide of the Co—Mo—O system which is not a specifically defined phase. The final step of the reduction-nitridation process results in the desired Co₃Mo₃N product without ammonia precursor.

FIGS. 10A-10C show representative TGA-DSC data. FIG. 10A shows representative TGA-DSC data after calcination of CoMoO₄ hydrate in He. FIG. 10B shows representative TGA-DSC data after reduction of CoMoO₄ under 10% H₂ balanced in He. FIG. 10C shows representative TGA-DSC data after nitridation process of CoMo under N₂.

FIG. 11 shows representative TGA data obtained after nitridation of Fe under N₂.

FIGS. 12A-12B show representative data for dielectric properties for CoMo and Fe samples. Dielectric data were collected as described in Examples herein below. FIG. 12A shows representative data for dielectric properties for fresh CoMoO₄, nitrided CoMo, reduced CoMo, and SIC as indicated in the graph. FIG. 12Bshows representative data for dielectric properties for Fe powder and SIC as indicated in the graph.

FIG. 13 shows representative data for ammonia production rate and temperature ramp during the initial N₂ nitridation process for a disclosed pre-reduced CoMo bimetallic.

FIG. 14 shows representative data for pre-reduced compounds CoMoO₄, MoO₃, and Mo and their relative ammonia productivity on nitridation by N₂.

FIGS. 15A-15D shows XPS results for CoMo samples treated in various ways. FIG. 15A shows N₂-nitrided peaks for Mo 3p; FIG. 15B shows 15% NH₃ balanced in Ar, nitrided Mo 3p peaks; FIG. 15C shows Co 2p peaks; and FIG. 15D shows Mo 3d peaks.

FIG. 16 shows Raman spectroscopy results for CoMo samples treated.

FIGS. 17A-17B show schematic representations of various aspects of reaction mechanism relating to the disclosed methods and processes. FIG. 17A describes proposed mechanism explaining the observation of both ammonia and water synthesis occurring in a reduced CoMo bimetallic with no gaseous Ha present. FIG. 17B shows further proposed aspects of the reaction representing a dynamic surface and unreduced core.

FIG. 18 shows a schematic diagram showing the effect of penetration depth in which “d” and “Dₚ” indicated in the figure is, respectively, particle diameter and penetration depth of microwave irradiation. Briefly, without wishing to be bound by a particular theory, it is believed that if the size of the particle is on the order of the penetration depth, then the entire particle becomes “skin” and heating is volumetric. However, if the particle is too small, the particle may become invisible to the irradiation, a problem possibly encountered with certain nanoparticle catalysts under microwave conditions. Finally, if the particle is too large the surface skin effect will reflect the radiation and heating will be non-uniform, which may also occur if conductive particles share electrons forming a “super-particle” which may reflect incident radiation.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a catalyst,” “a reactor,” or “a metal,” including, but not limited to, two or more, including plurality, of such catalysts, reactors, or metals and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about X’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a catalyst, microwave energy, flow rate, and the like, refers to an amount or number that is sufficient to achieve the desired improvement in the property modulated by the formulation component, e.g., nitridation of a catalyst. The specific level in terms of amount or number required as an effective amount will depend upon a variety of factors, e.g., for a given catalyst such factors can include the composition of the catalyst, the flow rate of reactant materials, the composition of the reactant materials, energy constraints, efficiency of an reaction, and the like.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

It should be emphasized that the above-described aspects of the present disclosure, including the appendices which constitute a part of the present disclosure, are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### Abbreviations

Abbreviations used herein throughout:

| Abbreviation | Meaning |
|---|---|
| CLAS | Chemical looping ammonia synthesis |
| CTFB | Continuous flow conventional thermal fixed |
| | bed |
| H-B | Haber-Bosch process |
| MW | Microwave |
| MWFB | Continuous flow microwave fixed bed |
| SEM | Scanning electron microscopy |
| TGA | Thermogravimetric analysis |
| XRD | X-ray diffraction (unless otherwise specified, |
| | understood to be powder XRD) |

### Technological Context

In addition to the use of ammonia in fertilizer production, ammonia may also be used as a future source of green energy (J. Guo and P. Chen, Chem, 2017, 3, 709-712). Ammonia conversion can be performed by combustion as in the AmVeh gas/ammonia powered car or by catalytic decomposition, electrolyzed or used in fuel cells releasing only N₂ and H₂O [5-7]. An additional benefit of ammonia as potential energy vector is the high solubility of ammonia in water, making it much simpler to transport than hydrogen (A. Klerke, et al., J. Mater. Chem., 2008, 18, 2304; and C. Zamfirescu and I. Dincer, J. Power Sources, 2008, 185, 459-465).

Conventional industrial ammonia synthesis proceeds by the Haber-Bosch (HB) process which operates at high temperatures of 300-500° C., and high pressure 20-100 MPa range. The reaction relies on carbon catalyst systems with multi-promoted iron or ruthenium metal loadings (M. Appl, in Ullmann's Encyclopedia of Industrial Chemistry, Wiley-VCH Verlag GmbH & Co. KGaA, Weinheim, 2006). In Equation 1 (ibid), the ammonia synthesis reaction is given:

$$3 {H}_{2} + {N}_{2} ⇌ 2 {NH}_{3} ΔH = - 46.35 {kJmol}^{- 1} \qquad Equation 1$$

The reaction is thermodynamically limited due to its high exothermicity. The HB process is rate limited and requires high temperature and high pressures to be kinetically viable.

Chemical looping ammonia synthesis (CLAS) is a reaction scheme to decouple the ammonia synthesis reaction as traditionally understood in HB (H. Yan, et al., J. Phys. Chem. C, 2021, 125, 6716-6722). Storing fixed nitrogen may be a way of dealing with the intermittent power supplies that can be expected from renewable power sources, as well as a strategy to overcome the thermodynamic barrier encountered in HB ammonia synthesis (L. Green, Jr., Int. J. Hydrog. Energy, 1982, 7, 355-359; and S. Giddey, et al., ACS Sustain. Chem. Eng., 2017, 5, 10231-10239). This kind of cyclic operation may pose a problem for traditional plants with large energy requirements for compression and temperature control, in addition natural gas and coal sourced hydrogen are also expected to be impacted by climate change (X. Liu, et al., Green Chem., 2020, 22, 5751-5761).

The disclosed CLAS reaction follows the following simplified chemical reaction. In Equation 2, the metallic powder is reacted with gas-phase dinitrogen to form the metal-nitride phase. Equation 3 represents the metal nitride system, which can contain various nitride phases, is reacted with gaseous hydrogen to produce ammonia. This process of metal-nitride formation and nitrogen reduction to form ammonia is a cyclic repeatable process.

$$xM + {N}_{2} \to {M}_{x} {N}_{y} … + MN \qquad Equation 2$$

$${M}_{x} {N}_{y} + {H}_{2} \to {M}_{x} {N}_{y - z} + {z NH}_{3} \qquad Equation 3$$

CLAS systems may provide an alternative process technology then, to overcome these barriers. Modular systems may be designed at or near sources of renewable energy or near the point of use to reduce the distance to ship ammonia. Microwave (MW) heating proceeds through different physical mechanisms than traditional thermal heating, thus microwave heating may provide a means to “switch” bed temperatures very rapidly, among other possible benefits allowing modular CLAS to approach competitiveness with HB systems.

MW heating technology offers a variety of potential benefits over conventional thermal heating owing to the difference in the physical processes by which heating occurs. Microwave frequen-cies are defined as those between 300 MHz and 300 GHz (Chapter 2: Microwaves—Theory, in: M. Gupta, et al., Microwaves and Metals, John Wiley & Sons (Asia) Pte Ltd, Singapore, 2011: pp. 25-41). Uniform and non-uniform heating modes exist and depend upon the size, geometry, electric permittivity, and magnetic permeability of particles (H. Will, et al., Chem. Eng. Technol. 27 (2004) 113-122; and R. R. Mishra and A. K. Sharma, Compos. Part Appl. Sci. Manuf., 2016, 81, 78-97). The definition of the permittivity is given in Equation 4 below where ε* is the relative permittivity, which is made up of, ε′ the real permittivity, which is related to energy storage, and ε″, the complex permittivity which is related to loss processes:

$${ε}^{*} = {ε}^{′} - j {ε}^{″} \qquad Equation 4$$

The loss tangent or, tan(δ) Equation 5, describes the ability of the material to convert absorbed energy into heat and is a useful measure to characterize supported catalysts for microwave reaction engineering (Chapter 2: Microwaves-Theory, in: M. Gupta, et al., Microwaves and Metals, John Wiley & Sons (Asia) Pte Ltd, Singapore, 2011: pp. 25-41; J. Hu, et al., Chem. Eng. J., 2020, 397, 125388; and R. Tempke, et al., Measurement & Technology, 2020, 14, 972-978).

$$tan ( δ ) = \frac{{ε}^{″}}{{ε}^{′}} \qquad Equation 5$$

Despite the advantages of microwave reaction systems and appreciation of various theoretical aspects of such systems, there has not heretofore been a disclosure of suitable catalyst systems using microwave energy to efficiently produce ammonia in a scalable process.

The present disclosure provides suitable single metals and bimetallic alloys demonstrated under realistic reactor conditions that show the effectiveness of microwave heating for enhanced ammonia productivity compared to thermal heating methods. The present disclosure provides suitable catalyst materials and methods using same for the effective and economical production of ammonia using microwave energy.

### Disclosed Methods for Chemical Looping Synthesis

In an aspect, the present disclosure pertains to methods for ammonia-synthesis-on-nitridation under atmosphere of pure N₂ gas was observed with a reduced CoMo bimetallic CLAS material.

In an aspect, the disclosure relates to a process or method for synthesis of a nitrided catalyst composition, the method including urging or flowing a reactant gas comprising nitrogen gas (N₂) into a reaction chamber and over a catalyst composition to form a reaction composition, heating the chamber and/or the reaction composition; wherein the total gas pressure in the reaction chamber is about from about 0.5 atm to about 5 atm

In an aspect, the total nitridation (gas) reaction pressure is from about 0.4 atm to about 1.5 atm or from about 0.4 atm to about 1.3 atm, or from about 0.4 atm to about 1.2, or from about 0.5 atm to about 1.2 atm, or from about 0.5 atm to about 1.1 atm, or from about 0.6 atm to about 1.1 atm, or from about 0.7 atm to about 1.2 atm, or from about 0.7 atm to about 1.1 atm, or from about 0.7 to about 1.0 atm, or from about 0.8 atm to about 1.2 atm or from 0.9 atm to about 1.2 atm or from 0.9 atm to about 1.1 atm, or from 0.9 to about 1.0 atm, or from about 1.0 to about 1.1 atm.

In an embodiment, the nitrogen may be admixed with an inert carrier gas or a reactive gas. In this manner, the partial pressure of nitrogen at the reaction temperature may comprise from about 5% to about 100%, or from about 10% to about 100%, or from about 15% to about 100%, or from about 20% to about 100%, or from about 25% to about 100%, or from about 30% to about 100%, or from about 35% to about 100%, or from about 40% to about 100%, or from about 45% to about 100%, or from about 50% to about 100%, or from about 55% to about 100%, or from about 60% to about 100%, or from about 65% to about 100%, or from about 70% to about 100%, or from about 75% to about 100%, or from about 80% to about 100%, or from about 85% to about 100%, or from about 90% to about 100%, or from about 95% to about 100% of the total gas pressure in the reaction chamber.

In an aspect the disclosed process utilizes variable microwave energy and a catalyst to efficiently the synthesize nitrided catalyst composition, and thereafter, ammonia from a reactant gas mixture comprising hydrogen and nitrogen.

In an aspect, the disclosed process utilizes a reactor configuration is such that reactor tube passing through the waveguide (along the direction of H-Field wave propagation). Such a reactor configuration can be associated with improved heating efficiency compared to the scenario where the process tube passes through the broad wall of the wave guide. In a further aspect, the microwave energy is variably tuned. even with a fixed frequency microwave energy.

In a further aspect, a reactor configuration comprising variable-frequency microwave (VFM) can allow extended reaction operating times. In a still further aspect, the VFM can vary the frequency from 5.85 to 6.65 GHz. In a yet further aspect, any single frequency from the VFM bandwidth can be used, or the entire bandwidth can be rapidly swept in a fraction of a second, thereby allowing tuned excitation at frequencies associated with specific peaks in the loss tangent of the dielectric spectrum.

In a further aspect, the microwave reactor is a high-pressure microwave reactor, a multimode microwave reactor and/or a monomode progressive microwave reactor. In a further aspect, the microwave reactor is a progressive wave design microwave reactor.

In a further aspect, the reactor chamber is a quartz tube reactor chamber where the quartz tube reactor chamber has a quartz tube portion and a metal tube portion that is connected to the quartz tube portion via a pyrex glass/metal transition connector.

In a further aspect, the microwave reactor and reactor chamber is shielded with a transparent thermoplastic or thermoset tube that provides safety from any possible explosion that takes place within the microwave reactor.

In an aspect, the reaction chamber may comprise a thermal heater, e.g., a radiant heater.

In a further aspect, the microwave reactor and reactor chamber reactant gas mixtures and product effluent are analyzed with a gas chromatograph, or other means known to the person of ordinary skill.

In an aspect, the nitrided catalyst composition comprises Mn, Fe, Co—Mo, or combinations thereof. In a further aspect, the nitrided catalyst composition comprises Co—Mo. In a still further aspect, the nitrided catalyst composition comprises CoMoO₄.

In an aspect, the nitrided catalyst composition may be admixed with a microwave energy sorbent composition, thereby forming a disclosed catalyst composition further comprising a microwave energy sorbent (or microwave energy absorber). In some instances, the microwave energy sorbent may be an insulating microwave energy sorbent composition, i.e., a microwave energy sorbent that is electrically insulating. In a further aspect, the microwave energy sorbent can be selected from a metal sulfide (e.g., Ag₂S, CuS, MoS₃, PbS, ZnS, FeS, FeS₂, or combinations thereof); a metal carbide (e.g., SiC, W₂C, B₄C, or combinations thereof); a metal nitride (e.g., TIN); a ceramic material (e.g., a SiOC ceramic or ZrBr₂); a carbon material such as, but not limited to, a form of carbon such as graphite, carbon fibers, carbon nanotubes, carbon black, or combinations thereof; a clay (e.g., a sepiolite clay); and/or water; or combinations of the foregoing. In some aspects, the microwave energy sorbent is an insulating microwave energy sorbent composition such as SiC.

In a further aspect, the microwave energy sorbent can comprise a metal, a metal salt, metal oxide, a metal nitride, a metal carbide, a metal sulfide, a hydrated salt, a carbon, a clay, a silicate, a ceramic, a zeolite, a silica, an alumina, a titania gel, a vermiculate, an attapulgite, a molecular sieve, or combinations thereof. In a further aspect, a microwave energy sorbent present as a metal salt can be CuXₙ where n is an integer from 1 to 6 and X is a halogen; ZnX₂ or SnX₂ where X is a halogen, or combinations thereof. In a still further aspect, a microwave energy sorbent present as hydrated salt can be NiCl₂·6H₂O, Al₂(SO₄)₃·18H₂O, or combinations thereof. In a yet further aspect, a microwave energy absorber present as a metal oxide can be present as CuO, NIO, Fe₃O₄, Co₂O₃, BaTiO₃, or combinations thereof. In an even further aspect, a microwave energy sorbent present as a metal sulfide can be Ag₂S, CuS, MoS₃, PbS, ZnS, FeS, FeS₂, or combinations thereof. In various further aspects, a microwave energy sorbent present as a metal carbide can be SiC, W₂C, B₄C, or combinations thereof. A variety of different metal nitrides are suitable for use as a microwave energy sorbent, including, but not limited to TIN.

In a further aspect, a microwave energy sorbent can be present as carbon in the form of graphite, carbon fibers, carbon nanotubes, carbon black, or combinations thereof. A carbon black can be any suitable form for use as a microwave energy sorbent such a nanoparticle or a microparticle. A variety of different clays are suitable for use as a microwave energy sorbent, including, but not limited to a sepiolite clay. In some aspects, a microwave energy sorbent can further comprise water. In various aspects, a microwave energy sorbent has an average particle size of from about 0.1 nanometers to about 50 micrometers.

In an aspect, the catalyst-insulator composition may be substantially homogeneous. In another aspect, the amount of insulator microwave energy sorbent composition may comprise from about 5% to about 100%, or from about 10% to about 100%, or from about 15% to about 100%, or from about 20% to about 100%, or from about 25% to about 100%, or from about 30% to about 100%, or from about 35% to about 100%, or from about 40% to about 100%, or from about 45% to about 100%, or from about 50% to about 100%, or from about 55% to about 100%, or from about 60% to about 100%, or from about 65% to about 100%, or from about 70% to about 100%, or from about 75% to about 100%, or from about 80% to about 100%, or from about 85% to about 100%, or from about 90% to about 100%, or from about 95% to about 100% of the catalyst-insulator composition, by weight.

In an aspect, the average particle size the catalyst composition is about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, or about 100 microns (μ). In the list of particle sizes the particles size may comprise a range from any one number to another number. For example, a particle size may be from about 20 μ to about 61μ.

In an aspect, the average particle size of the insulating microwave sorbent composition is about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, or about 100 microns (μ). In the list of particle sizes, the particle size may comprise a range from one number to another. For example, a particle size may be from about 1 μ to about 20μ.

In an aspect, any heating step may comprise heating, by microwave or otherwise, to a temperature of about 100° C., about 150° C., about 200° C., about 250° C., about 300° C., about 350° C., about 400° C., about 450° C., about 500° C., about 550° C., about 600° C., about 650° C., about 700° C., about 750° C., about 800° C., about 850° C., about 900° C., about 950° C., about 1000° C., about 1050° C., about 1100° C., about 1150° C., or about 1200° C. In the list of temperatures, the temperature may comprise a range from one number to another. For example, a temperature may be from about 500° C. to about 900° C.

### Aspects

The following listing of exemplary aspects supports and is supported by the disclosure provided herein.

Aspect 1. A method for synthesis of a nitrided catalyst composition, the method comprising: providing a reaction chamber; providing a catalyst composition in the reaction chamber; flowing a reactant gas into the reaction chamber and over the catalyst composition; wherein the reactant gas in contact with the catalyst composition forms a reaction composition; wherein the reactant gas comprises nitrogen; heating the reaction chamber; wherein the heating is carried out at a nitridation reaction pressure of from about 0.5 atm to about 5 atm; thereby synthesizing the nitrided catalyst composition.

Aspect 2. The method of Aspect 1, wherein the reaction chamber is a reaction chamber in a fixed bed reactor.

Aspect 3. The method of Aspect 1, wherein the reaction chamber is a reaction chamber in a continuous bed reactor.

Aspect 4. The method of Aspect 1, wherein the reaction chamber is a reaction chamber in a fluidized bed reactor.

Aspect 5. The method of any one of Aspect 1-Aspect 4, wherein the catalyst composition comprises Mn, Fe, Co—Mo, or combinations thereof.

Aspect 6. The method of Aspect 5, wherein the catalyst composition comprises Mn.

Aspect 7. The method of Aspect 5, wherein the catalyst composition comprises Fe.

Aspect 8. The method of Aspect 5, wherein the catalyst composition comprises Co—Mo.

Aspect 9. The method of any one of Aspect 1-Aspect 8, wherein the nitridation reaction pressure is from about 0.9 atm to about 1.1 atm.

Aspect 10.1. The method of any one of Aspect 1-Aspect 9, further comprising a microwave energy sorbent composition mixed with the catalyst composition, thereby forming a catalyst-microwave energy sorbent composition.

Aspect 10.2. The method of any one of Aspect 1-Aspect 9, further comprising an insulating microwave energy sorbent composition mixed with the catalyst composition, thereby forming a catalyst-insulating microwave energy sorbent composition.

Aspect 11.1. The method of Aspect 10.1, wherein the microwave energy sorbent composition comprises SiC.

Aspect 11.2. The method of Aspect 10.2, wherein the insulating microwave energy sorbent composition comprises SiC.

Aspect 11.3. The method of Aspect 10.1, wherein the microwave energy sorbent composition is selected from a metal, a metal salt, metal oxide, a metal sulfide, a metal carbide, a metal nitride, a hydrated salt, a ceramic material, a carbon material, a clay, a silicate, a zeolite, a silica, an alumina, a titania gel, a vermiculate, an attapulgite, a molecular sieve, water, and combinations of the foregoing.

Aspect 11.4. The method of Aspect 11.3, wherein the microwave energy sorbent composition is selected from Ag₂S, CuS, MoS₃, PbS, ZnS, FeS, FeS₂, MoS₃, PbS, ZnS, CuO, NiO, Fe₃O₄, Co₂O₃, BaTiO₃, SIC, W₂C, B₄C, TiN, NiCl₂·6H₂O, Al₂(SO₄)₃·18H₂O, a SiOC ceramic, a ZrBr₂ ceramic, graphite, carbon fibers, carbon nanotubes, carbon black, a sepiolite clay, water; and combinations of the foregoing.

Aspect 12. The method of Aspect 10.1, Aspect 10.2, or Aspect 11.1-11.4, wherein the insulating microwave energy sorbent composition and the catalyst composition are homogeneously distributed in the catalyst-insulator composition.

Aspect 13. The method of any one of Aspect 1-Aspect 12, wherein the heating comprises thermally heating the reaction chamber using a heat source, irradiation of the reaction chamber with microwave energy, or a combination thereof.

Aspect 14. The method of Aspect 13, wherein the heating comprises irradiation of the reaction chamber with microwave energy.

Aspect 15. The method of Aspect 14, wherein the heating provides a temperature of from about 400° C. to about 1000° C. in the reaction chamber, in the catalyst composition, in the reactant gas, in the reaction composition, or combination thereof.

Aspect 16. The method of Aspect 13, wherein the heating comprises thermally heating the reaction chamber using a heat source.

Aspect 17.1. The method of Aspect 16, wherein the heating provides a temperature of from about 400° C. to about 600° C. in the reaction chamber, in the catalyst composition, in the reactant gas, in the reaction composition, or combination thereof.

Aspect 17.2. The method of Aspect 16, wherein the heating provides a temperature of from about 400° C. to about 700° C. in the reaction chamber, in the catalyst composition, in the reactant gas, in the reaction composition, or combination thereof.

Aspect 17.3. The method of Aspect 16, wherein the heating provides a temperature of from about 400° C. to about 800° C. in the reaction chamber, in the catalyst composition, in the reactant gas, in the reaction composition, or combination thereof.

Aspect 17.4. The method of Aspect 16, wherein the heating provides a temperature of from about 400° C. to about 900° C. in the reaction chamber, in the catalyst composition, in the reactant gas, in the reaction composition, or combination thereof.

Aspect 17.5. The method of Aspect 16, wherein the heating provides a temperature of from about 500° C. to about 1000° C. in the reaction chamber, in the catalyst composition, in the reactant gas, in the reaction composition, or combination thereof.

Aspect 17.6. The method of Aspect 16, wherein the heating provides a temperature of from about 500° C. to about 600° C. in the reaction chamber, in the catalyst composition, in the reactant gas, in the reaction composition, or combination thereof.

Aspect 17.7. The method of Aspect 16, wherein the heating provides a temperature of from about 500° C. to about 700° C. in the reaction chamber, in the catalyst composition, in the reactant gas, in the reaction composition, or combination thereof.

Aspect 17.8. The method of Aspect 16, wherein the heating provides a temperature of from about 500° C. to about 800° C. in the reaction chamber, in the catalyst composition, in the reactant gas, in the reaction composition, or combination thereof.

Aspect 17.9. The method of Aspect 16, wherein the heating provides a temperature of from about 500° C. to about 900° C. in the reaction chamber, in the catalyst composition, in the reactant gas, in the reaction composition, or combination thereof.

Aspect 17.10. The method of Aspect 16, wherein the heating provides a temperature of from about 500° C. to about 1000° C. in the reaction chamber, in the catalyst composition, in the reactant gas, in the reaction composition, or combination thereof.

Aspect 17.11. The method of Aspect 16, wherein the heating provides a temperature of from about 600° C. to about 600° C. in the reaction chamber, in the catalyst composition, in the reactant gas, in the reaction composition, or combination thereof.

Aspect 17.12. The method of Aspect 16, wherein the heating provides a temperature of from about 600° C. to about 700° C. in the reaction chamber, in the catalyst composition, in the reactant gas, in the reaction composition, or combination thereof.

Aspect 17.13. The method of Aspect 16, wherein the heating provides a temperature of from about 600° C. to about 800° C. in the reaction chamber, in the catalyst composition, in the reactant gas, in the reaction composition, or combination thereof.

Aspect 17.1. The method of Aspect 16, wherein the heating provides a temperature of from about 600° C. to about 900° C. in the reaction chamber, in the catalyst composition, in the reactant gas, in the reaction composition, or combination thereof.

Aspect 17.14. The method of Aspect 16, wherein the heating provides a temperature of from about 600° C. to about 1000° C. in the reaction chamber, in the catalyst composition, in the reactant gas, in the reaction composition, or combination thereof.

Aspect 18. The method of Aspect 13, wherein the heating comprises irradiation of the reaction chamber with microwave energy and thermally heating the reaction chamber using a heat source.

Aspect 19. The method of any one of Aspect 1-Aspect 18, wherein the catalyst composition has an average particle size less than about 15 μm.

Aspect 20. The method of Aspect 19, wherein the catalyst composition has an average particle size of from about 1 nm to about 15 μm.

Aspect 21. The method of Aspect 19, wherein the catalyst composition has an average particle size of from about 1 μm to about 15 μm.

Aspect 22. The method of any one of Aspect 1-Aspect 21, wherein the insulating microwave energy sorbent composition has an average particle size less than about 100 μm.

Aspect 23. The method of Aspect 22, wherein the insulating microwave energy sorbent composition has an average particle size less than about 75 μm.

Aspect 24. The method of Aspect 22, wherein the insulating microwave energy sorbent composition has an average particle size less than about 50 μm.

Aspect 25. The method of Aspect 22, wherein the insulating microwave energy sorbent composition has an average particle size less than about 25 μm.

Aspect 26. The method of Aspect 22, wherein the insulating microwave energy sorbent composition has an average particle size less than about 15 μm.

Aspect 27. The method of Aspect 22, wherein the insulating microwave energy sorbent composition has an average particle size of from about 1 nm to about 50 μm.

Aspect 28. The method of Aspect 22, wherein the insulating microwave energy sorbent composition has an average particle size of from about 1 μm to about 50 μm.

Aspect 29. A nitrided catalyst composition prepared by the method of any one of Aspect 1-Aspect 28.

Aspect 30. A method for synthesis of ammonia, the method comprising: providing a reaction chamber; providing the nitrided catalyst composition of Aspect 29; flowing a reactant gas into the reaction chamber and over a catalyst composition; wherein the reactant gas comprises hydrogen; wherein reactant gas in contact with the catalyst composition forms an ammonia reaction composition; heating the reaction chamber; thereby sythesizing ammonia.

Aspect 31. The method of Aspect 30, wherein the reaction chamber is a reaction chamber in a fixed bed reactor.

Aspect 32. The method of Aspect 30, wherein the reaction chamber is a reaction chamber in a continuous bed reactor.

Aspect 33. The method of Aspect 30, wherein the reaction chamber is a reaction chamber in a fluidized bed reactor.

Aspect 34. The method of any one of Aspect 30-Aspect 33, wherein the heating is carried out at a reaction pressure of from about 0.5 atm to about 5 atm.

Aspect 35. The method of Aspect 34, wherein the reaction pressure is about 0.9 atm to about 1.1 atm.

Aspect 36. The method of any one of Aspect 30-Aspect 35, wherein the heating comprises thermally heating the reaction chamber using a heat source, irradiation of the reaction chamber with microwave energy, or a combination thereof.

Aspect 37. The method of Aspect 36, wherein the heating comprises irradiation of the reaction chamber with microwave energy.

Aspect 38. The method of Aspect 37, wherein the heating provides a temperature of from about 400° C. to about 1000° C., or any of the temperatures disclosed in Aspect 17.1-Aspect 17.14, in the reaction chamber, in the catalyst composition, in the reactant gas, in the reaction composition, or combination thereof.

Aspect 39. The method of Aspect 36, wherein the heating comprises thermally heating the reaction chamber using a heat source.

Aspect 40. The method of Aspect 39, wherein the heating provides a temperature of from about 400° C. to about 1000° C., or any of the temperatures disclosed in Aspect 17.1-Aspect 17.14, in the reaction chamber, in the catalyst composition, in the reactant gas, in the reaction composition, or combination thereof.

Aspect 41. The method of Aspect 36, wherein the heating comprises irradiation of the reaction chamber with microwave energy and thermally heating the reaction chamber using a heat source.

Aspect 42. Ammonia prepared by the method of any one of Aspect 30-Aspect 41.

Aspect 43. A method for synthesis of ammonia, the method comprising: providing a reaction chamber; providing a catalyst composition in the reaction chamber; flowing a first reactant gas into the reaction chamber and over the catalyst composition; wherein the reactant gas in contact with the catalyst composition forms a reaction composition; wherein the reactant gas comprises nitrogen; heating the reaction chamber in a first heat step; wherein the heating is carried out at a nitridation reaction pressure of from about 0.5 atm to about 5 atm; thereby synthesizing a nitrided catalyst composition; purging the reaction chamber with a gas; flowing a second reactant gas into the reaction chamber and over the nitrided catalyst composition; wherein the reactant gas comprises hydrogen; and wherein the reactant gas in contact with the catalyst composition forms an ammonia reaction composition; heating the reaction chamber in a second heating step; thereby synthesizing ammonia.

Aspect 44. The method of Aspect 43, wherein the reaction chamber is a reaction chamber in a fixed bed reactor.

Aspect 45. The method of Aspect 43, wherein the reaction chamber is a reaction chamber in a continuous bed reactor.

Aspect 46. The method of Aspect 43, wherein the reaction chamber is a reaction chamber in a fluidized bed reactor.

Aspect 47. The method of any one of Aspect 43-Aspect 46, wherein the catalyst composition comprises Mn, Fe, Co—Mo, or combinations thereof.

Aspect 48. The method of Aspect 47, wherein the catalyst composition comprises Mn.

Aspect 49. The method of Aspect 47, wherein the catalyst composition comprises Fe.

Aspect 50. The method of Aspect 47, wherein the catalyst composition comprises Co—Mo.

Aspect 51. The method of any one of Aspect 43-Aspect 50, wherein the nitridation reaction pressure is from about 0.9 atm to about 1.1 atm.

Aspect 52. The method of any one of Aspect 43-Aspect 51, further comprising an insulating microwave energy sorbent composition mixed with the catalyst composition, thereby forming a catalyst-insulator composition.

Aspect 53. The method of Aspect 52, wherein the insulating microwave energy sorbent composition comprises SIC.

Aspect 54. The method of Aspect 52 or Aspect 53, wherein the insulating microwave energy sorbent composition and the catalyst composition are homogeneously distributed in the catalyst-insulator composition.

Aspect 55. The method of any one of Aspect 43-Aspect 54, wherein the first step heating step comprises thermally heating the reaction chamber using a heat source, irradiation of the reaction chamber with microwave energy, or a combination thereof.

Aspect 56. The method of Aspect 55, wherein the first step heating step comprises irradiation of the reaction chamber with microwave energy.

Aspect 57. The method of Aspect 56, wherein the first step heating step provides a temperature of from about 400° C. to about 1000° C., or any of the temperatures disclosed in Aspect 17.1-Aspect 17.14, in the reaction chamber, in the catalyst composition, in the reactant gas, in the reaction composition, or combination thereof.

Aspect 58. The method of Aspect 55, wherein the first step heating step comprises thermally heating the reaction chamber using a heat source.

Aspect 59. The method of Aspect 58, wherein the first step heating step provides a temperature of from about 400° C. to about 1000° C., or any of the temperatures disclosed in Aspect 17.1-Aspect 17.14, in the reaction chamber, in the catalyst composition, in the reactant gas, in the reaction composition, or combination thereof.

Aspect 60. The method of Aspect 55, wherein the first step heating step comprises irradiation of the reaction chamber with microwave energy and thermally heating the reaction chamber using a heat source.

Aspect 61. The method of any one of Aspect 43-Aspect 60, wherein the catalyst composition has an average particle size less than about 15 μm.

Aspect 62. The method of Aspect 61, wherein the catalyst composition has an average particle size of from about 1 nm to about 15 μm.

Aspect 63. The method of Aspect 61, wherein the catalyst composition has an average particle size of from about 1 μm to about 15 μm.

Aspect 64. The method of any one of Aspect 43-Aspect 63, wherein the insulating microwave energy sorbent composition has an average particle size less than about 100 μm.

Aspect 65. The method of Aspect 64, wherein the insulating microwave energy sorbent composition has an average particle size less than about 75 μm.

Aspect 66. The method of Aspect 64, wherein the insulating microwave energy sorbent composition has an average particle size less than about 50 μm.

Aspect 67. The method of Aspect 64, wherein the insulating microwave energy sorbent composition has an average particle size less than about 25 μm.

Aspect 68. The method of Aspect 64, wherein the insulating microwave energy sorbent composition has an average particle size less than about 15 μm.

Aspect 69. The method of Aspect 64, wherein the insulating microwave energy sorbent composition has an average particle size of from about 1 nm to about 50 μm.

Aspect 70. The method of Aspect 64, wherein the insulating microwave energy sorbent composition has an average particle size of from about 1 μm to about 50 μm.

Aspect 71. The method of any one of Aspect 43-Aspect 70, wherein the second heating step is carried out at an ammonia reaction pressure of from about 0.5 atm to about 5 atm.

Aspect 72. The method of Aspect 71, wherein the ammonia reaction pressure is from about 0.9 atm to about 1.1 atm.

Aspect 73. The method of any one of Aspect 43-Aspect 72, wherein the second heating step comprises thermally heating the reaction chamber using a heat source, irradiation of the reaction chamber with microwave energy, or a combination thereof.

Aspect 74. The method of Aspect 73, wherein the second heating step comprises irradiation of the reaction chamber with microwave energy.

Aspect 75. The method of Aspect 74, wherein the second heating step provides a temperature of from about 400° C. to about 1000° C., or any of the temperatures disclosed in Aspect 17.1-Aspect 17.14, in the reaction chamber, in the catalyst composition, in the reactant gas, in the reaction composition, or combination thereof.

Aspect 76. The method of Aspect 73, wherein the second heating step comprises thermally heating the reaction chamber using a heat source.

Aspect 77. The method of Aspect 76, wherein the second heating step provides a temperature of from about 400° C. to about 1000° C., or any of the temperatures disclosed in Aspect 17.1-Aspect 17.14, in the reaction chamber, in the catalyst composition, in the reactant gas, in the reaction composition, or combination thereof.

Aspect 78. The method of Aspect 77, wherein the second heating step comprises irradiation of the reaction chamber with microwave energy and thermally heating the reaction chamber using a heat source.

Aspect 79. Ammonia prepared by the method of any one of Aspect 43-Aspect 78.

Aspect 80. A method as disclosed herein to prepare a nitrided catalyst composition.

Aspect 81. A method as disclosed herein to prepare ammonia.

Aspect 82. Ammonia prepared by a method as disclosed herein.

Aspect 83. A nitrided catalyst composition as disclosed herein.

Aspect 84. A nitrided catalyst composition prepared by method as disclosed herein.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Materials and Methods

Materials and General Instruments. Cobalt molybdenum oxide hydrate (CoMoO₄, ˜325 mesh, 99.9%, Alfa Aesar), manganese powder (Mn(0), ˜325 mesh, 99.9%, Aldrich), iron powder (Fe(0), <10 μm, >99.9%, Aldrich) were tested as chemical looping ammonia synthesis materials. Silicon carbide (SiC, 98%, 325 mesh, Aldrich) was used as an insulating microwave energy sorbent to enhance heating. Inlet reactant gases were of ultra-high purity grade (99.999%):H₂, N₂, Ar, 10% H₂ balanced in He cylinders; and the gases were supplied by Matheson and Airgas, Inc. Outlet gases were measured by Thermo Fisher Scientific Prima Benchtop Mass Spectrometer and by gas phase CAI 600 Fourier Transform Infrared Spectroscopy (FTIR) to determine product concentrations.

Reactor Methods. A continuous flow conventional tubular thermal fixed bed (CTFB) and a continuous flow microwave fixed bed (MWFB) were used. Both reactors utilized quartz tubes (406.4 mm L, 10 mm ID, 12 mm OD) to contain the catalyst between quartz wool supports in the center of the tube. All reactions were performed at atmospheric pressure. The ammonia synthesis reaction, or hydrogenation step, was performed three times for each chemical looping candidate. The procedure for each reaction is detailed below for both the CTFB and MWFB reactors.

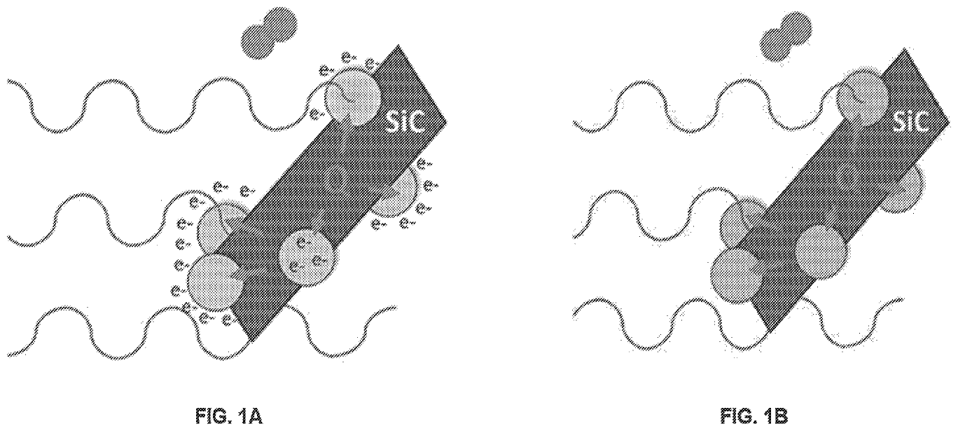

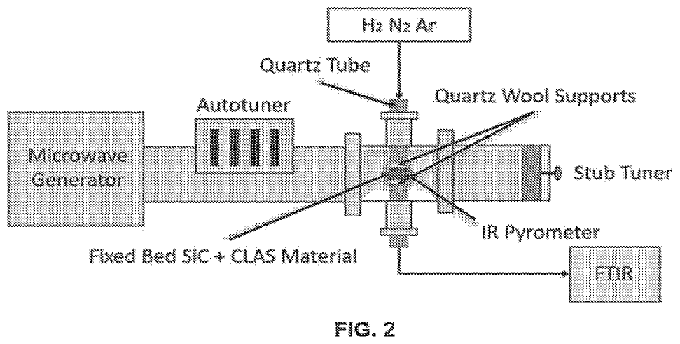

Chemical Looping. A representative schematic diagram of the chemical looping process is presented in FIGS. 1A-1B. Initiation steps include reduction of the oxide precursors followed by nitridation to the active phase, hydrogenation to form ammonia and eventual deactivation leading to the formation of multiple stable inactive phases, which ultimately breaks the cycle. Briefly, without wishing to be bound by a particular theory, FIG. 1A shows microwave irradiation is absorbed by metal particles that results in volumetric heating in both metal particles and SIC, e.g., heat conducted from SIC particles to metal particles and electrons are pushed to the surface where they can activate neutral molecules, e.g., N₂. Further, without wishing to be bound by a particular theory, FIG. 1B shows that as metal particles are nitrided, they become more electrically insulating and the heating process requires more energy to heat volumetrically and by conduction from SiC.

Thermal Fixed Bed Reactor Testing. The thermal fixed bed consisted of a standard programmable tube furnace using a 24° C.·min⁻¹ ramp rate. Chemical looping candidates were tested by mass using 500 mg samples physically mixed with 500 mg of inert SiC to maintain equivalent gas space velocity and dispersion with microwave. Cobalt molybdenum oxide was pre-reduced for 3 h at 750° C. in 50 MI·min⁻¹ of H₂ gas flow. Nitridation was performed under N₂ gas flow at 50 MI·min⁻¹ for 1 h at 600° C. for CoMoO₄, for 1 h at 600° C. for Mn, and for 1 h at 450° C. for Fe samples. Hydrogenation under 50 MI·min⁻¹ H₂, was performed at 450° C. for 1 h to synthesize ammonia. The reactor system was purged with 50 MI·min⁻¹ Ar gas for 5 min between after each ammonia synthesis step of the chemical looping reaction cycle.

Microwave Fixed Bed Reactor Testing. Microwave testing was performed in a fixed frequency, 2.45 GHz, 2 KW, magnetron powder, single mode cavity microwave from Sairem (model GMP20K). The temperature was measured using a laser aligned infrared pyrometer (IR) from Micro-Epsilon (model CTLM3) with a pre-calibrated temperature range between 20° and 1500° C. This device measures the surface infrared emittance of the reaction tube and contents. A manual sliding short was tuned to minimize MW leakage and to focus the beam on the sample.

Samples tested in MW consisted of 500 mg of chemical looping candidates physically mixed until homogenized with 500 mg of SIC, which acts as an insulating MW absorber. Typical power applied for MW heating ranged between 300 and 700 W.

Sample nitridation was performed using MW heating at temperatures of 600° C. for CoMo, and for 450° C. for Fe at 50 mL min⁻¹ N₂ flow for 1 h. Hydrogenation under 50 mL min⁻¹ H₂, was performed at 450° C. for 15 min to synthesize ammonia. The reactor system was again purged with 50 mL·min⁻¹ Ar gas for 5 min between each reaction step of the chemical looping reaction cycle.

Characterization Methods. Powder x-ray diffraction (XRD) characterization was performed using PANalytical X'Pert Pro X-ray Diffractometer with CuKα radiation at 45 KV and 40 mA in the range from 10° and 20° to 100° (2θ) at a scan rate of 5°·min⁻¹.

Thermogravimetric analysis (TGA) was performed with TA Instruments SDT-650 thermogravimetric analyzer in 90 μL alumina crucibles. Typical operation included sample purge for 1 h under 50 mL·min⁻¹ flow of 10% H₂ balanced in 100 mL·min⁻¹ He, 150 mL·min⁻¹ He, or 50 mL min⁻¹ N₂ balanced in 100 mL min⁻¹ He, followed by a 5° C.·min⁻¹ ramp to 750° C. Temperature and flow rates were maintained for 3-4 h in the TGA.

Scanning electron microscopy (SEM) was performed on a Hitachi S-4700 Scanning Electron Microscope to determine particle size and morphology. Inductively coupled plasma optical emission spectroscopy (ICP-OES) was performed to determine the composition of spent bimetallic samples.

Thermal imagining of the microwave catalyst bed was performed by an infrared thermal imaging camera (FLIR model number A6261). The camera was positioned 0.5 m away from the quartz waveguide port. FLIR Research Max software was used to analyze the temperature distribution recorded at each pixel of the bed.

Pulse chemisorption was performed on a Micromeritics Autochem 2950 using UHP N₂. BET analysis was performed using a Micromeritics ASAP 2020 adsorption analyzer.

Dielectric property measurement was performed between 100 MHz and 9 GHz using a Keysight P5002A vector network analyzer with a 7 mm by 3.12 cm air line (Maury Microwave model number 2653S3.12). Calibration was performed using a Keysight 85091C electronic calibration model on the autocalibration setting. The powdered materials of interest were included in a paraffin wax (Aldrich, mp 53-58° C.) matrix at 10% volume loading, homogenized, and cast into a plug following the method in R. Tempke, C. Wildfire, D. Shekhawat and T. Musho, IET Science, Measurement & Technology, 2020, 14, 972-978. The Landau-Lifshits-Loonyenga equation was used to separate the dielectric properties of the matrix and the powdered samples (see equation immediately below). Where εₘᵢₓ is the measured property, Vₘ is the volume of the matrix, εₘ is the dielectric property of the matrix, Vₚ is the volume of the particle, and Ep is the dielectric property of the particle.

$$Landau - Lifshits - Loonyenga equation :$$

$${ε}_{mix}^{1 / 3} = {( {v}_{m} {ε}_{m} )}^{1 / 3} + {( {v}_{p} {ε}_{p} )}^{1 / 3}$$

### 2. Microwave and Conventionally Heated Chemical Looping Ammonia Synthesis-Experimental Data

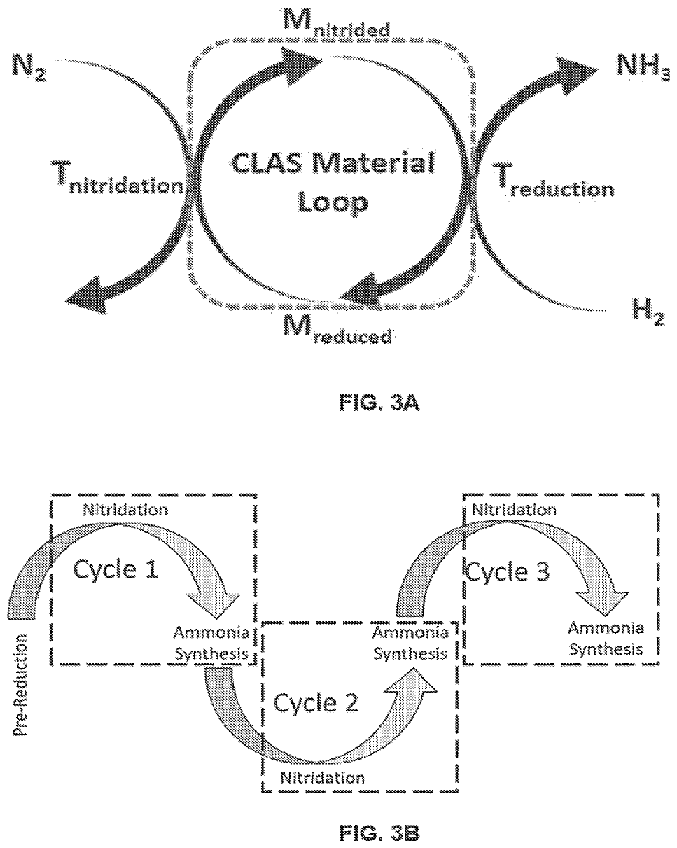

A representative schematic diagram of the three-cycle chemical looping process is presented in FIGS. 3A-3B. Initiation steps include reduction of the oxide precursors followed by nitridation to the active phase, hydrogenation to form ammonia, and the eventual deactivation leading to the formation of multiple stable inactive phases, which ultimately breaks the cycle. The ammonia synthesis reaction, or hydrogenation step, was performed three times for each chemical looping candidate.

Reaction Engineering. In the conventional art, there are reports of exotic materials for nitrogen chemical looping. The present disclosure evaluated single metals and bimetallic alloys in three ammonia synthesis cycles under realistic reactor conditions and to compare the effectiveness of MW heating for lowering the bulk temperature or duration of metal nitride formation reactions. CLAS candidates were selected based on the data herein, ready reducibility, and availability.

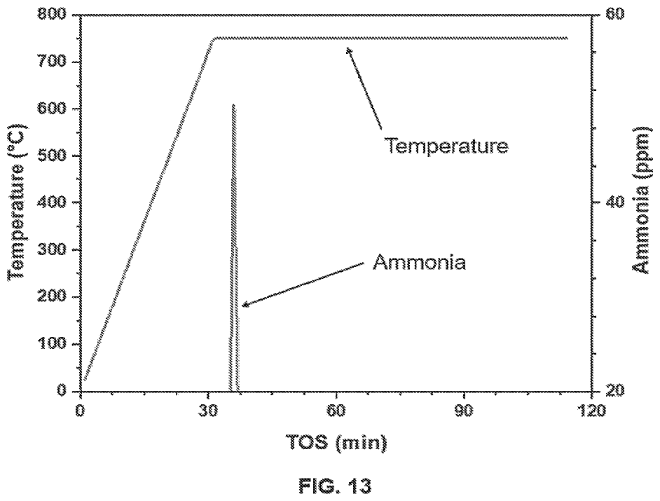

The present disclosure surprisingly found that synthesizing Co₃Mo₃N by pre-reduction with H₂ followed by nitridation by N₂ that on the initial nitridation step ammonia synthesis was observed in the absence of gaseous H₂. This ammonia-synthesis-on-nitridation step effect was unexpected, the system was usually cooled to 25° C. and purged with inert gas between reaction steps. This ammonia-synthesis-on-nitridation reaction proved to be an unexpected finding, and one not remarked upon before in the literature. FIG. 13 shows a generalizable result showing ammonia production rate and temperature ramp during the initial N₂ nitridation process for pre-reduced CoMo bimetallic for the foregoing.

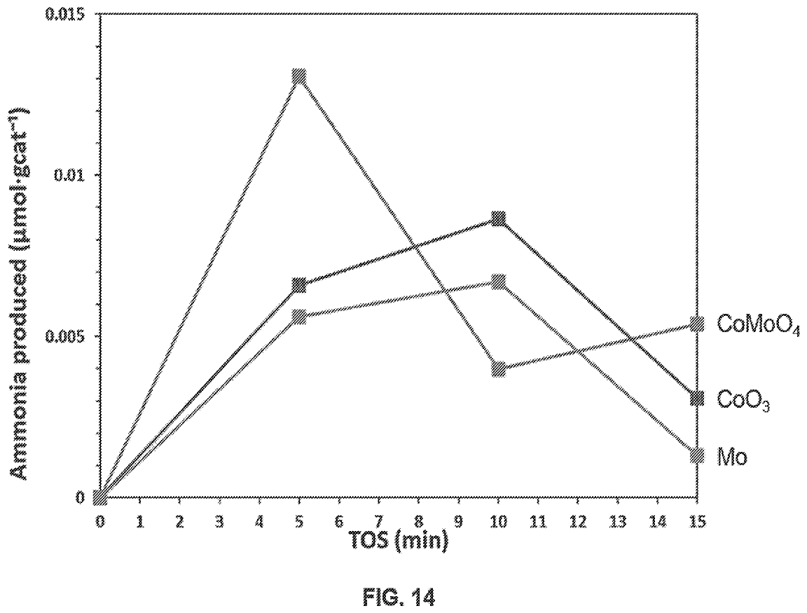

In order to assess whether the ammonia-synthesis-on-nitridation effect was limited to the CoMoO₄ alloy or if it was present in either Co or Mo systems each was tested independently. Samples of powdered Mo, MoO₂, MoO₃, Co₃O₄ and CoMoO₄ were tested under identical conditions. The results presented in FIG. 14 indicate that ammonia formation is very efficient with CoMoO₄ bimetallic under nitriding conditions. Without wishing to be bound by particular theory, it is believed that the data are consistent with ammonia formation may be related to MoO₃ within the CoMoO₄ bimetallic under nitriding conditions. In contrast, Mo metal appears to have a weak propensity towards ammonia-synthesis-on-nitridation, but-without wishing to be bound by a particular theory—it is believed this may be due to oxidation of the Mo metal surface in air. MoO₂ and Co₃O₄ were not found to have any significant ammonia synthesis activity under H₂ at 700° C. followed by N₂ at 700° C. Without wishing to be bound by a particular theory, it is believed that MoO₃ hydroxides may be involved in the observed chemistry.

Characterization of CoMoO₄ Particles. XPS, H₂-TPD, SEM, and Raman spectroscopy were all performed to analyze both the surface chemistry and bulk diffusion that led to ammonia-synthesis-on-nitridation. Scanning electron microscopy indicated very limited morphological changes in the particles between fresh oxide, nitride and spent states. Likewise, H₂-TPD of the reduced surface showed negligible H₂ absorption.

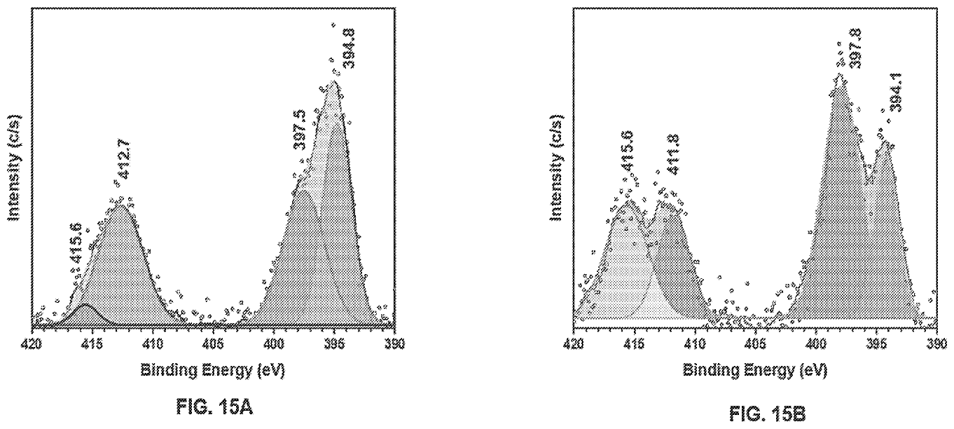

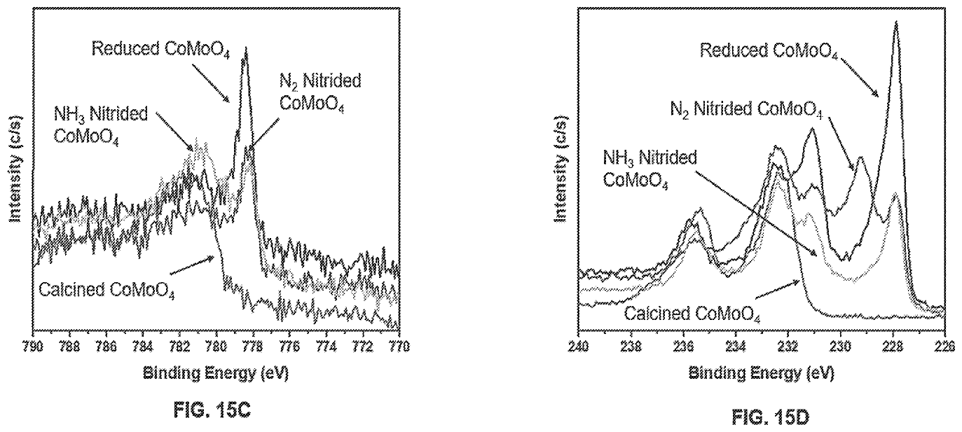

To understand the chemical composition present in the surface layers of the CoMo system, x-ray photoelectric spectroscopy was used. The results for the specific elemental scans are provided in FIGS. 15A-15D. Mo 3p (394 eV) peaks overlap with N 1s (397 eV) peaks and required deconvolution with OriginLab software. FIG. 15A shows that nitridation with N₂ results in relatively less N in surface as compared with FIG. 15B which shows a higher nitrogen signal in the surface post-treatment with 15% NH₃ balanced in Ar. Experimental evidence in this laboratory and theory suggests that the RDS of particle nitridation is the partial pressure of N, suggesting that this result is limited to the surface (Addemir, O., et al., High Temperature Materials and Processes 1996, 15 (4), 273-280).

FIG. 15C shows Co 2p peaks are compared amongst calcined, H₂ reduced and nitrided samples. Co⁰ (777 eV) peaks can be observed most strongly in the H₂ reduced sample, with the intensity of the NH₃ and N₂ nitrided samples somewhat reduced. Oxidized Co 2p can be observed as Co³⁺ (781 eV) and Co²⁺ (779 eV), a trend then exists with the nitrided samples having less Co⁰ and increased Co³⁺ in the case of the NH₃ treated sample.

FIG. 15D shows the collected Mo 3d peaks present the triplet associated with the chemical states of Mo⁰, Mo⁴⁺, and Mo⁶⁺. The calcined sample is the exception, only the Mo⁶⁺ peak is present associated with the higher oxidation MoO₃ present in the bimetallic. The same oxidation state trend observed for the Co 2p peaks is observed for the Mo 3d peaks: Mo⁰ (228 eV) is increased after H₂ reduction, the N₂ nitrided system shows the existence of the Most (229 eV) and Mo⁶⁺ (233 eV) oxidation states (Hada, K., et al., Journal of Catalysis 2002, 207 (1), 10-22). The Mo⁵⁺ represents an oxynitride while Mo⁶⁺ is representative of the presence of the fully oxidized MoO₃ (Podila, S., et al., International Journal of Hydrogen Energy 2017, 42 (12), 8006-8020). The relative red shifting observed in the nitrided samples is representative of the uptake and oxidation by nitrogen. The proposed reaction mechanism begins with surface nitridation, followed by the counter-diffusion of nitrogen into the bulk and oxygen out of the core.

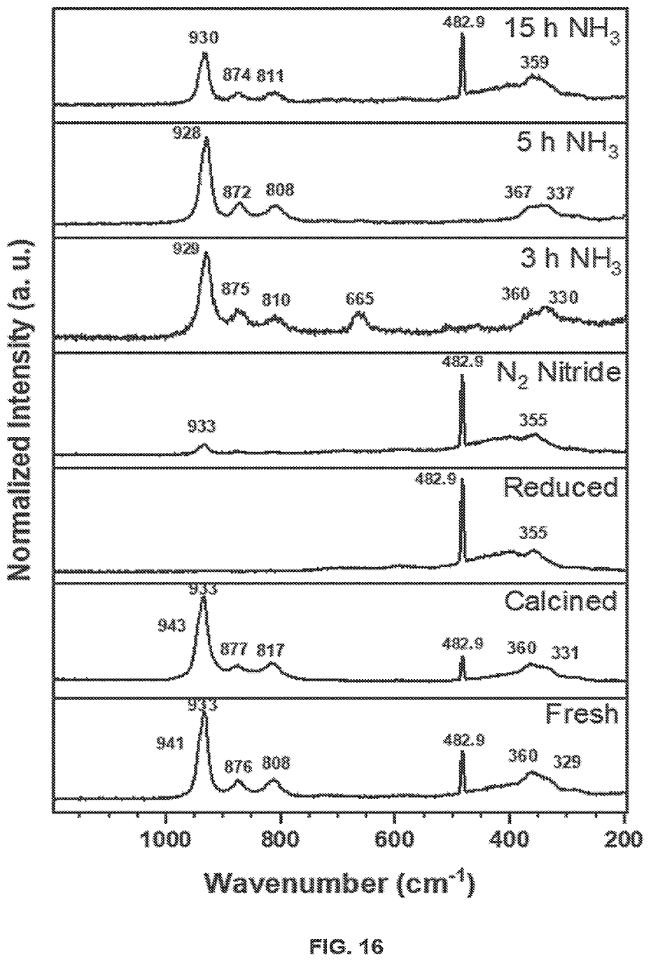

Raman spectroscopy was used to determine the bulk, rather than surface, oxidation state of the particles. The results of which are presented in FIG. 16 for different CoMo systems. The oxidation state changes can be observed in the Raman results between fresh CoMo, calcined CoMo, reduced CoMo, and the various nitrided samples. Between the fresh and the samples calcined at 250° C. for 5 h, the peak attributable to Co and its oxides at 483 cm⁻¹ is observed to reduce in intensity and the spectrum is clearer. The 3 h H₂ reduction yields a spectrum where the oxide peaks related to MoO₃, 943, 933, 877, 817 cm⁻¹ are no longer present. However, on 3 h N₂ nitridation the 933 cm⁻¹ is observed to return, indicating an increased oxidation state and the presence of MoO₃ in the bulk structure.

The samples treated in a 15% NH₃/Ar atmosphere present interesting results. The oxidation states for the various times of treatment show a show reduction in oxidation state despite the more aggressive nitriding agent. This is attributable to the slowly reacting shell where when interpolating from the XPS the shell is more fully nitride by NH₃ but at less depth. This reinforces the confirmation of partial pressure of N as the driving force of nitridation in the bulk, but not the surface scale.

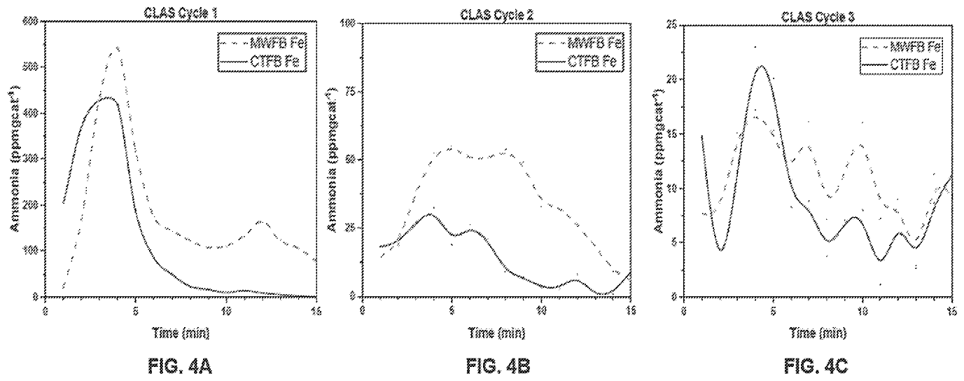

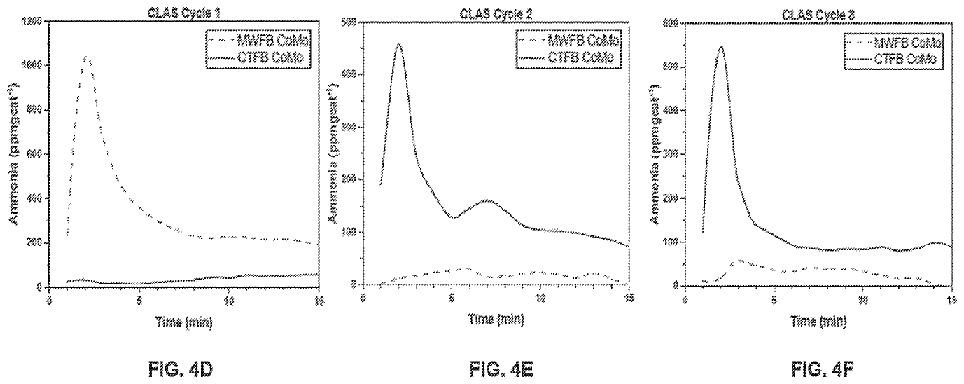

Time on stream experiments was performed for both the CTFB and the MWFB with identical operating conditions. CoMo and Fe systems were examined at 450° C. for 15 min under H₂ flow. The results of these experiments performed in three CLAS cycles are shown in FIGS. 4A-4F.

FIGS. 4A-4F show representative data for time on stream experiments for Fe and CoMo systems for three CLAS cycles, comparing continuous flow conventional thermal fixed bed (CTFB) and a continuous flow microwave fixed bed (MWFB) under identical reaction conditions. The studies were carried out at 450° C. for 15 minutes under hydrogen flow. FIGS. 4A-4C show representative in which the reaction system comprise iron particles, whereas FIGS. 4D-4F comprised CoMo as disclosed herein. The lines showing comparison between CTFB and MWFB are as indicated in the figure. FIG. 4A shows representative experimental data for a CTFB reaction for CLAS cycle #1 carried out in a reaction system comprising Fe particles where the reaction was conducted at 450° C. for 15 minutes under hydrogen flow. FIG. 4B shows representative experimental data for a CTFB reaction for CLAS cycle #2 carried out in a reaction system comprising Fe particles where the reaction was conducted at 450° C. for 15 minutes under hydrogen flow. FIG. 4C shows representative experimental data for a CTFB reaction for CLAS cycle #3 carried out in a reaction system comprising Fe particles where the reaction was conducted at 450° C. for 15 minutes under hydrogen flow. FIG. 4D shows representative experimental data for a CTFB reaction for CLAS cycle #1 carried out in a reaction system comprising CoMo where the reaction was conducted at 450° C. for 15 minutes under hydrogen flow. FIG. 4E shows representative experimental data for a CTFB reaction for CLAS cycle #2 carried out in a reaction system comprising CoMo where the reaction was conducted at 450° C. for 15 minutes under hydrogen flow. FIG. 4F shows representative experimental data for a CTFB reaction for CLAS cycle #3 carried out in a reaction system comprising CoMo where the reaction was conducted at 450° C. for 15 minutes under hydrogen flow.

As seen in the foregoing, for the CLAS cycle 1, the MWFB system resulted in a significantly higher ammonia production rate in comparison to the CTFB for both the Fe and CoMo catalyst systems. CLAS Cycle 1-3 for the CoMo system shows significant deactivation for ammonia production for the MWFB in comparison to CTFB. However, the Fe system is found to continue to favor the MWFB to produce ammonia, until cycle 3 which is largely indeterminate.

Several possible explanations for the differences in performance between the CTFB system and the MWFB system exist. Without wishing to be bound by a particular theory, electronic activation appears to enhance ionic diffusion, and the rapid heating modes described above could lead to the advantage the disclosed microwave system presents. Further, without wishing to be bound by a particular theory, it is possible that deactivation may proceed via formation of various inactive phases and the loss of surface features due to MW heating.

Due to both its particle size <10 μm, and the ability of Fe to couple with both electric and magnetic fields, Fe performs the best of all samples considered. Fe metal is ferromagnetic and the heating process occurring is largely due to the internal eddy current variety which leads to volumetric heating. Mo is paramagnetic and does not couple well with MW radiation. Co metal is also ferromagnetic and does couple with microwave radiation, but the performance is offset by both the larger particle size of the CoMo sample, and the alloying with Mo. All samples were aided by the conductive heating from SiC, which, being insulating, prevented the entire catalyst bed from becoming conductive and simply reflecting MW energy.

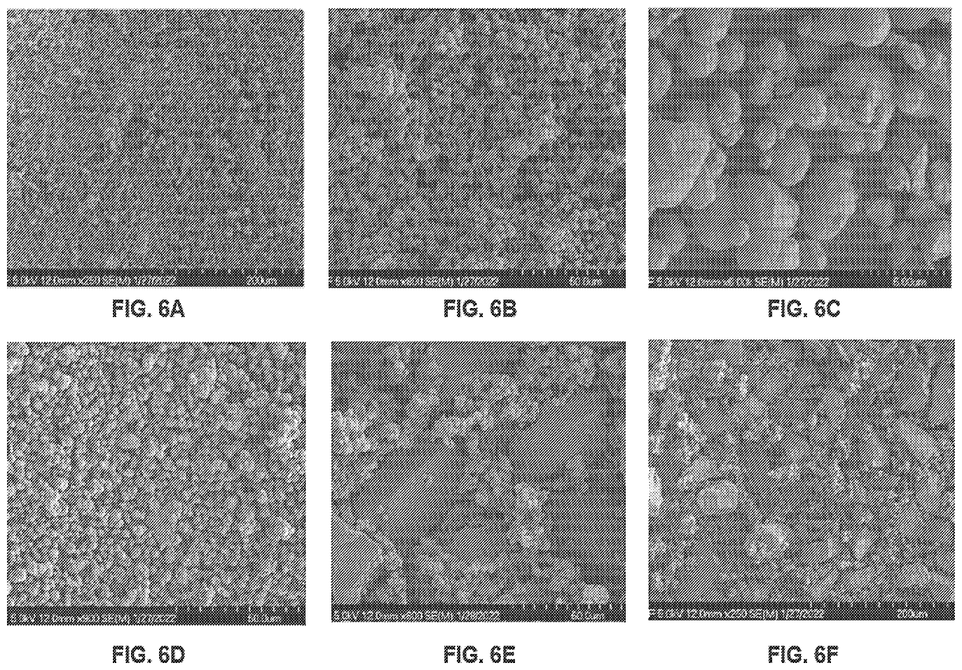

FIGS. 6A-6F show representative scanning electron micrographs showing representative morphology of representative disclosed reaction materials. Each micrograph image the scale is shown in the lower right of the image. FIG. 6A shows a representative scanning electron micrograph of fresh Fe powder. FIG. 6B shows a representative scanning electron micrograph of fresh Fe powder. FIG. 6C shows a representative scanning electron micrograph of nitrided Fe powder after CTFB for 1 h at 450° C., 50 mL/min. FIG. 6D shows a representative scanning electron micrograph of nitrided Fe powder after CTFB for 1 h at 450° C., 50 mL/min. FIG. 6E shows a representative scanning electron micrograph of a reaction materials after MWFB for three-cycles using Fe 1:1 physically mixed with SiC. FIG. 6F shows a representative scanning electron micrograph of a reaction materials after MWFB for three-cycles using Fe 1:1 physically mixed with SiC. The images indicate that the CTFB Fe powder had little morphological changes occurring between the fresh Fe powder and nitrided Fe powder (compare FIGS. 6A-6D). Moreover, the images show that spent Fe MWFB after three CLAS cycles (see FIGS. 6E-6F) show slight evidence of agglomeration, with FIG. 6F showing the somewhat greater agglomeration.

In the foregoing data, a discrepancy of 10° C.-40° C. in the MW setpoint controlled by an IR pyrometer. The temperature difference may be attributed to the mechanisms at which each collects IR irradiation from the surface of the sample and to the heating abilities and reactions occurring on the samples. The IR pyrometer can only observe a small fraction of the catalyst bed due to the small observation spot size, whereas the thermal imager observes the entire front-facing section of the catalyst bed. Therefore, a greater temperature distribution is observed when a per-pixel average is taken with the thermal imager due to heat losses at the top, bottom, and sides of the catalyst bed.

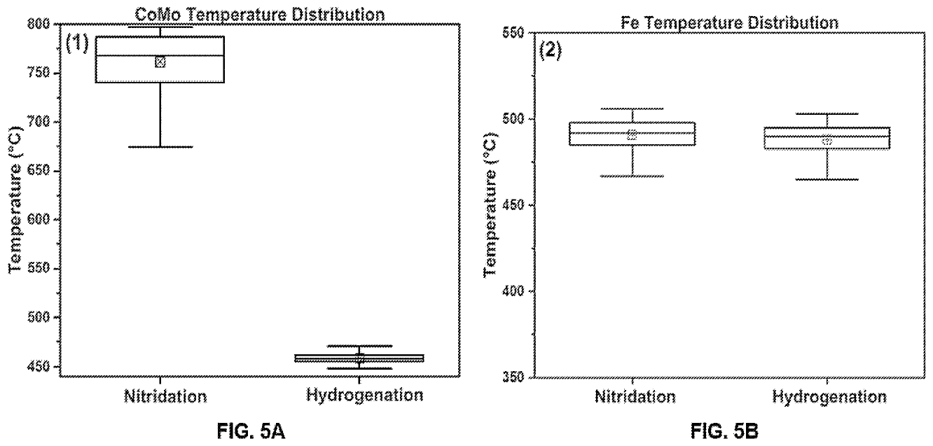

FIGS. 5A-5B show representative temperature distribution data for a disclosed process carried out under MWFB conditions comprising both N₂ and H₂ flow at 50 mL/min, as acquired by thermal imaging. The data were obtained from the thermal images, as described herein below, that were recorded during the nitridation and the hydrogenation step of the cyclic reactions. FIG. 5A shows a representative temperature distribution for a CoMo:SiC system where the set point was 750° C. and 450° C. respectively. FIG. 5B shows a representative temperature distribution for a Fe:SiC system where the set point is 450° C. The Fe samples exhibited higher microwave absorption than the CoMo samples resulting in a more rapid heat generation from within the sample. FIG. 5A depicts the Fe samples' heat distribution. The Fe sample nitridation step and the hydrogenation step both resulted in a similar temperature overshoot. Where the nitridation step and the hydrogenation step resulted in an on average temperature overshoot of about 40° C. from the 450° C. setpoint. The data for CoMo heating shown in FIG. 5B appears to have more accurate temperature control during cycle 1, with an average of 761° C. during nitridation and an average temperature of 459° C. during hydrogenation. The error bars at the 750° C. setpoints are large which are to be expected at such elevated temperatures.

While the 450° C. hydrogenation step is better controlled, this may be due to lower energy requirements for an exothermic hydrogenation reaction. In this setup, the thermal imager is used outside the waveguide and focused on the quartz tube through a secondary quartz port. The temperature pixel data is collected and then processed using basic descriptive statistics. There is a degree of error that is inherent in either temperature measurement system; the IR sensor averages colder with warmer regions within the spot size and the FLIR system does not compensate for emissivity changes; however, as both are <50° C. of each other this system is fairly accurate and consistent in temperature control. Dielectric properties are also subject to change with chemical and physical changes related to nitridation, oxidation, and hydrogenation as well as particle sintering and phase growth during heating processes.

To further understand the processes occurring during CLAS reactions, extensive material characterizations were carried out. SEM, Vector Network Analysis, ICP, TGA and XRD were useful to examine particle morphology, chemical, and phase changes when undergoing the nitridation and hydrogenation reactions.

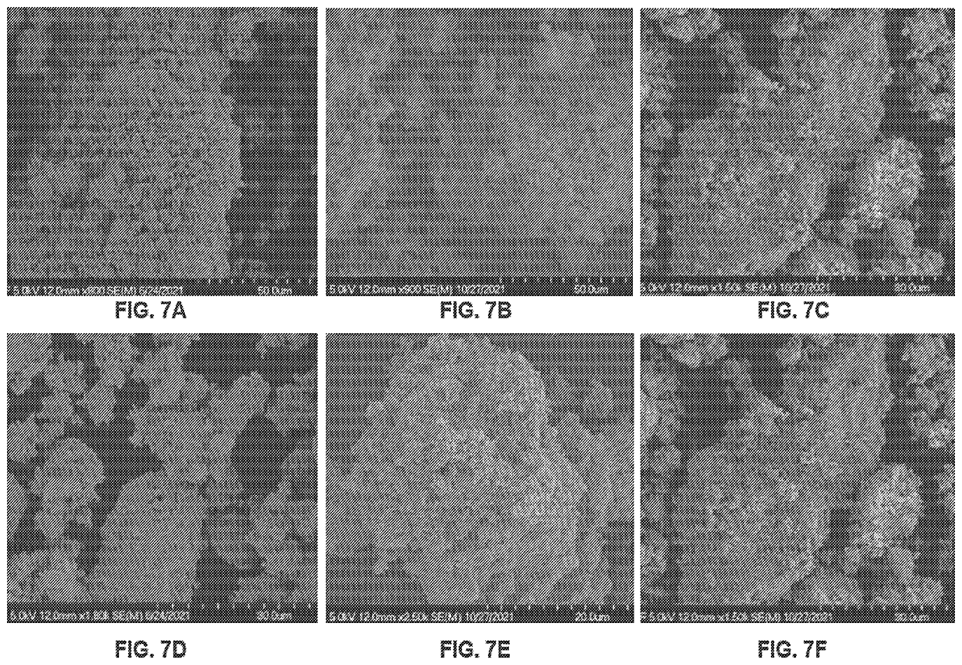

FIGS. 7A-7F show representative scanning electron micrographs showing representative morphology of representative disclosed reaction materials. Each micrograph image the scale is shown in the lower right of the image. FIG. 7A shows a representative scanning electron micrograph of fresh CoMoO₄ powder. FIG. 7B shows a representative scanning electron micrograph of fresh CoMoO₄ powder. FIG. 7C shows a representative scanning electron micrograph of CoMoO₄ powder after 3 h 750° C. reduction process under 50 mLmin⁻¹ H₂. FIG. 7D shows a representative scanning electron micrograph of CoMoO₄ powder after 3 h 750° C. reduction process under 50 mLmin⁻¹ H₂. FIG. 7E shows a representative scanning electron micrograph of a reaction materials comprising nitrided CoMo after both 3 h 750° C. reduction process under 50 mLmin⁻¹ H₂ followed by 1 h 750° C. nitridation process under 50 mLmin⁻¹ of N₂. FIG. 7F shows a representative scanning electron micrograph of a reaction materials comprising spent CoMo after both 3 h 750° C. reduction process under 50 mLmin⁻¹ H₂ followed by 1 h 750° C. nitridation process under 50 mLmin⁻¹ of N₂.

The bimetallic CoMo starts as an oxide which is calcined from the nitrate form leaving a textured surface. In the foregoing, FIGS. 7A-7B show very little change during the reduction step which results in a significant weight loss. CoMo volume typically decreases between the oxide precursor and the reduced samples, as shown in FIGS. 7C-7D. Finally, FIGS. 7E-7F show nitrided thermal three-cycle spent samples that appear to have no further volume change or modification of surfaces from the reduced samples in FIGS. 7C-7D.

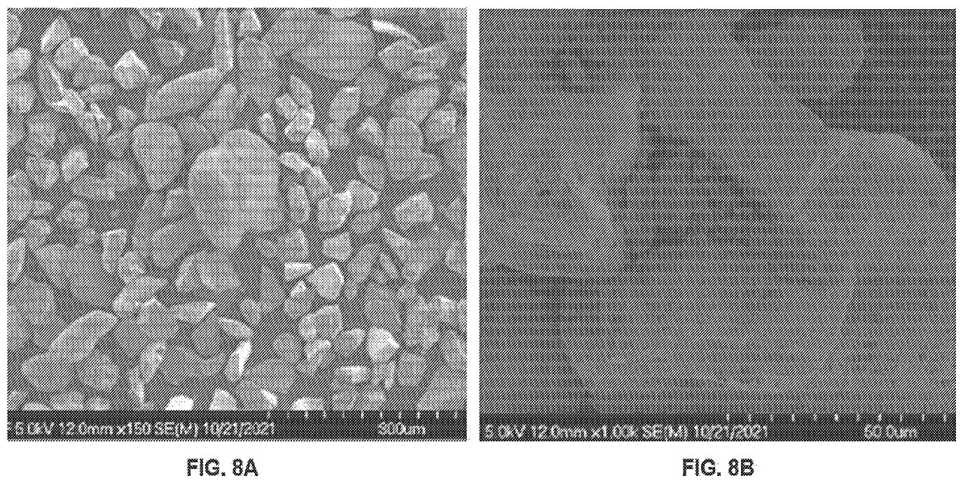

FIGS. 8A-8B show representative scanning electron micrographs showing representative morphology of representative disclosed reaction materials. Each micrograph image the scale is shown in the lower right of the image. Each of FIG. 8A and FIG. 8B shows a representative scanning electron micrograph of spent particles of CoMo:SiC after three cycles of MWFB carried out at 750 C 1 h 750° C. nitridation process under 50 mLmin⁻¹ of N₂. 1 h 750° C. nitridation process under 50 mLmin⁻¹ of N₂ followed by 1 h 450° C. hydrogenation process under 50 mLmin⁻¹ of H₂. These data show that spent MWFB CoMo samples are associated with very little evidence of agglomeration or significant morphological changes.

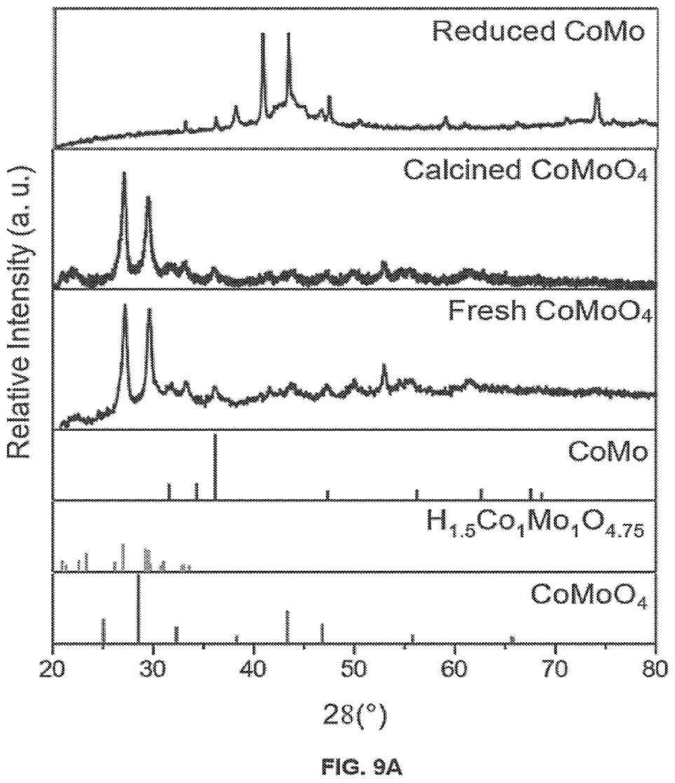

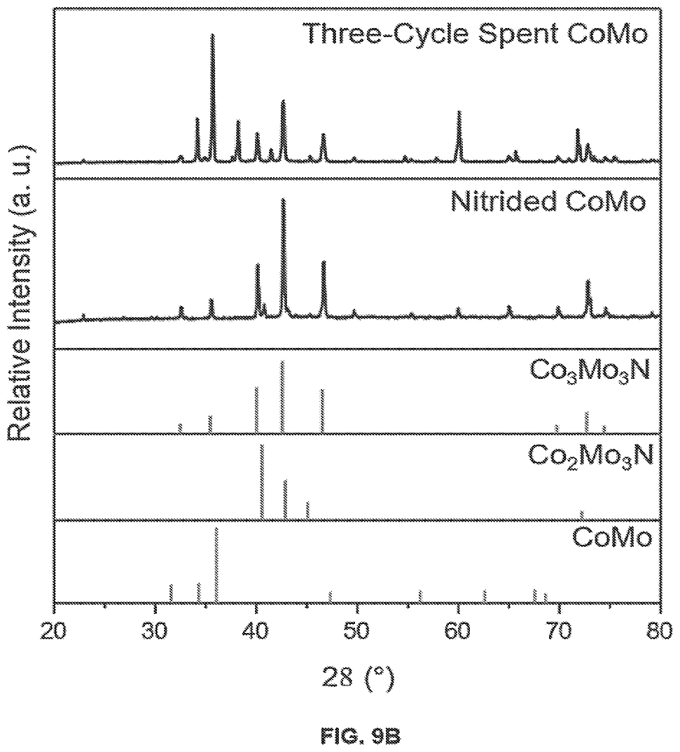

FIGS. 9A-9B show representative CoMoO₄ X-ray diffraction patterns of representative reaction materials after reaction under CLAS conditions. FIG. 9A shows a series of panels for CoMo oxide species as labeled therein, whereas FIG. 9B shows a series of panels for spent and nitrided CoMo oxide species as labeled therein. The structure characterization of the CoMo CLAS candidate was performed with XRD for each step of the reaction cycle; pre-reduction, nitridation, and spent samples. The data in FIG. 9A indicate that reduction and calcination processes likely do not remove all complexed water, or rather, result in a mixed-phase product finally resulting in a partially reduced system. The 3 h reduced CoMo system does not resemble CoMo metal alloy, nor the oxide precursor, so there may be a further intermediate collection of phases. The “intermediate” is a suboxide of the Co—Mo—O system which is not a specifically defined phase. The final step of the reduction-nitridation process results in the desired Co₃Mo₃N product without ammonia precursor.

The foregoing data of nitridation results suggest that the starting material for CLAS testing is indeed Co₃Mo₃N, the desired active phase. After three CLAS cycles, however, this material is degraded; and as such the coexistence of Co₂Mo₃N, Co₃Mo₃N, and a significant metallic and unreacted CoMo phase is inferred from the diffractograms. Without wishing to be bound by a particular theory, it is possible that the existence of these metallic phases is a deactivation route that these particles undergo, diffusion along grain boundaries is traditionally thought to be the fastest process but may lead to losses amongst metallic and partially nitrided phases due to slow intra-phase diffusion. Particle size and design could potentially be utilized to reduce and mitigate this effect, as well as high-temperature processing to anneal the crystal structure. During the time on stream experiments, metallic films were observed on the inner surface of the quartz tubes. Because this represents a mass loss from the material, it is important to understand the nature of this phenomenon and how it can alter yield, performance, and reproducibility.

The primary identity of the metallic films was found to be Mo, shown in Table 1. The ICP-OES results in Table 1 were collected from metal film coated quartz tube used in CLAS experiments that were washed with soap and water before being crushed and rinsed with fuming nitric acid. Loss of Mo at reaction temperatures used in the published literature, between 700° C. and 750° C., raised concern about the stability of the material for possible scale-up. Without wishing to be bound by a particular theory, the observed phenomenon may be due to the low vapor pressure of the MoO₃ species. In an aspect, pre-reduction of CoMoO₄ can be carefully performed with a low-temperature ramp rate to reduce the volatility of the MoO₃ species, which could result in mass loss and undesirable vapor phase reactions.

TABLE 1

| Sample | Co [wt %] | Mn [wt %] | Mo [wt %] |
|---|---|---|---|
| Spent Quartz | 0.01 | 0.09 | 99.90 |
| Reaction Tube | | | |

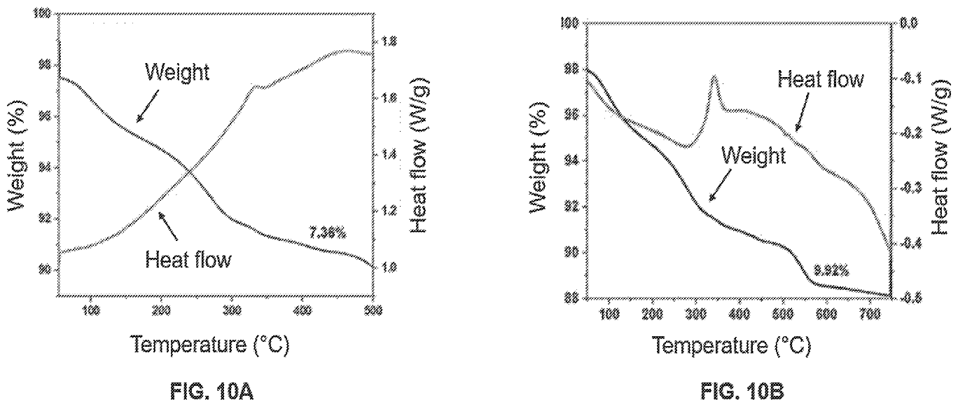

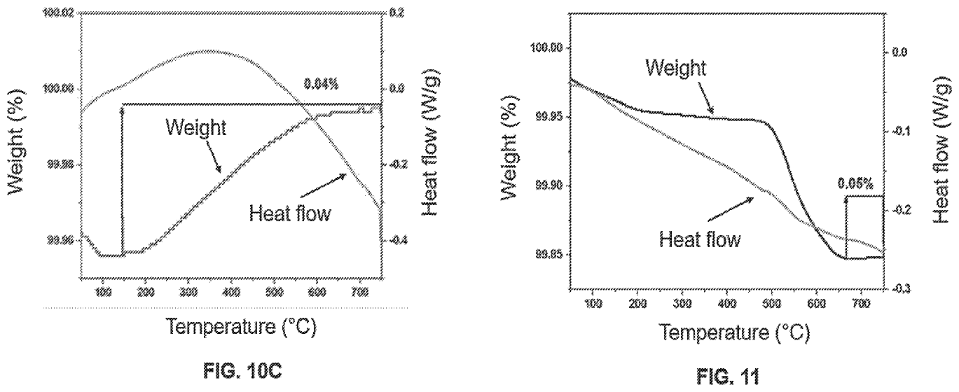

FIGS. 10A-10C show representative TGA-DSC data. FIG. 10A shows representative TGA-DSC data after calcination of CoMoO₄ hydrate in He. FIG. 10B shows representative TGA-DSC data after reduction of CoMoO₄ under 10% H₂ balanced in He. FIG. 10C shows representative TGA-DSC data after nitridation process of CoMo under N₂.

FIG. 10A shows a calcination process, where 7.36% mass loss is attributable to complexed water. The reduction process of CoMoO₄ is shown in FIG. 10B. The reduction process is very similar to the calcination process, it operates at 750° C. for 3 h, because the mass loss is 9.92% when it reaches temperature it can be inferred that the reduction process is slow compared with complex water loss, though these processes occur simultaneously. At 340° C. (see FIG. 11), an endothermic change is observed, likely attributable to phase rearrangement during the reduction as the same, but a slightly smaller peak is overserved in FIG. 10A. There is dehydration occurring at 610° C. where the β phase CoMoO₄ is formed. The XRD results indicate that a partially reduced system exists, this reflects the findings in our recent work on nitridation-stabilized ammonia synthesis and CoMo structure rearrangement during OH⁻¹ loss processes, the nitride phases appear to be free from H₂O.

Nitridation of the three CLAS candidates was carried out in the TGA to determine nitrogen uptake. Mass transfer limitation inside the TGA pan is speculated to be the cause of many of these nitridation results not approaching stoichiometric yields even after many hours. The CoMo material (see FIG. 10C) and Fe (see FIG. 11, which representative TGA data obtained after nitridation of Fe under N₂) both appear to show negligible nitrogen uptake in the TGA. From these data it may be inferred to be kinetically limited by gas phase diffusion to the particle surface. In contrast, prior approaches to CLAS materials synthesis and analysis were not performed under rigorous reaction engineering conditions with size, gas flow, and particle arrangement considered.

It has been theorized that multiple deactivation processes affect performance after the first CLAS cycle. In the CTFB, loss of surface area and phase segregation are believed to be the main issues. Although, the MWFB may suffer from the similar concerns, due to increased material kinetics and unique features of microwave heating, the deactivation process may happen faster and be dominated by altogether different deactivation processes.

BET surface areas were collected for the samples in their fresh, first nitridation cycle, second nitridation cycle, and three-cycle spent states for both CoMo and Fe in thermal and microwave reactors. Table 2 presents the results of these BET experiments, the pre-reduced CoMoO₄ suffers from a drastic reduction in surface are through the reduction-nitridation-hydrogenation reaction cycles losing ˜92% of its surface area. The Fe samples can be seen to suffer from reduced surface areas, but the starting surface area is extremely small, so the effect is limited.

TABLE 2

| | Fresh | CTFB Spent | MWFB Spent |
|---|---|---|---|
| CLAS Sample | [m²/g] | 1:1 SiC [m²/g] | 1:1 SiC [m²/g] |
| Fe | 0.62 | 0.35 | 0.47 |
| CoMo | 1.18 | 3.68 | 1.33 |

*1:1 CLAS Sample:SiC is physically mixed by mass.

A pulse N₂ chemisorption was performed for both pre-reduced CoMoO₄ and Fe samples for two cycles. The gas injection was precisely controlled, and the process was repeated until the signal in the outlet stream remained stable, indicating that the sample was saturated. The Fe samples were treated at 450° C. and the CoMo sample was treated at 750° C. Next, the sample was reduced with H₂ at 450° C. for 30 min and the N₂ injection was repeated.

To examine the effects of deactivation by surface area losses, the pulse N₂ chemisorption was repeated for both CoMo and Fe. The Fe samples was treated at 450° C. and the CoMo sample was treated at 750° C. Next, the sample was reduced with H₂ at 450° C. for 30 min and the N₂ injection was repeated. To regenerate the catalyst a 10% O₂ balanced in Ar gas was passed over the samples for 0.5 h at 450° C.

The results presented in Table 3 were obtained from pulse N₂ chemisorption tests for both Fe and CoMo samples. Two cycles were used to determine N₂ uptake. The samples were nitrided, reduced and renitrided. The second set of N₂ uptake experiments featured a nitride, reduction, oxidation, and nitridation step. The data in Table 3 indicate that the CoMo was negatively affected by the low-level oxygen treatment, while Fe experienced a slight increase in N₂ uptake. Without wishing to be bound by a particular theory, this may be attributable to the increase in surface oxidation of Fe which increases surface area for adsorption. The O₂ treatment of CoMo further removes the active phase Co₃Mo₃N.

TABLE 3

| | | | | N₂ Volume |
|---|---|---|---|---|
| | N₂ Uptake | N₂ Uptake | N₂ Volume | Uptake Cycle |
| | Cycle 1 | Cycle 2 | Uptake | 2, post |
| CLAS | [Peak | [Peak | Cycle 1 | oxidation |
| Sample | Area] | Area] | [mL] | [mL] |
| Fe | 0.1478 | 0.1040 | 0.1448 | 0.1508 |
| CoMo | 0.1443 | 0.1506 | 0.1355 | 0.1062 |

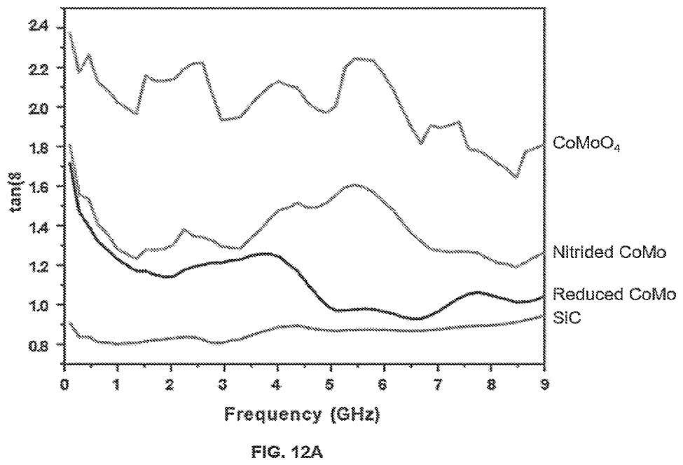

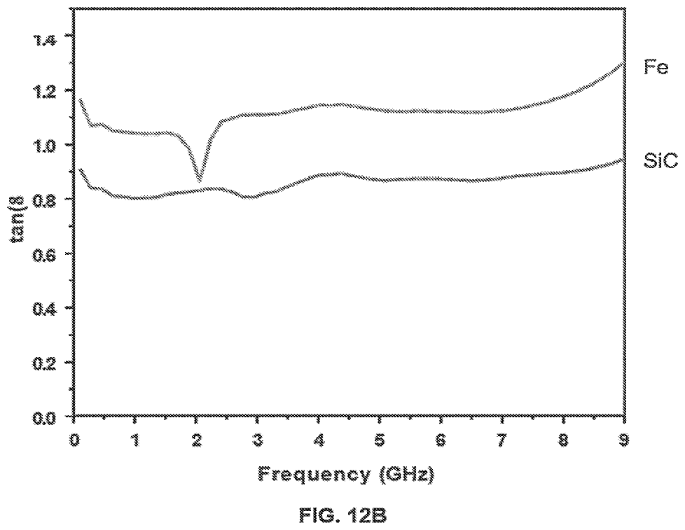

The dielectric properties of the 1:1 CLAS material SiC were measured using a Vector Network Analyzer. The dielectric properties recorded can be presented in the loss tangent which is a ratio of how lossy a material is to how conductive it is. The results are presented in FIGS. 12A-12B, which show representative data for dielectric properties for CoMo and Fe samples. FIG. 12A shows representative data for dielectric properties for fresh CoMoO₄, nitrided CoMo, reduced CoMo, and SiC as indicated in the graph. FIG. 12B shows representative data for dielectric properties for Fe powder and SIC as indicated in the graph. These data indicate the results of the various stable chemical states that made up the CLAS reactions. Nitrided Fe was not examined in the network analyzer because of the inherent instability of the compound.

The biggest limitation to the dielectric measurements is that the magnetic component is not included. This is a critical portion of the way that microwave energy couples with magnetic particles. However, the exact contribution of both the electrical and magnetic components is not well understood.

With physical mixing the particles are included together in a randomized orientation throughout the fixed bed reactor matrix. The particles were tested individually in the network analyzer, CoMoO₄, the precursor and both the reduced and nitrided forms were also tested.

The trends which can be inferred from the results in FIGS. 12A-12B are that materials tend to heat best when they are in an optimal zone somewhat greater than 1 loss tangent. However, as the chemical nature of the system changes, such as with nitrided CoMo, the system becomes more difficult to heat and requires more microwave input energy. From FIGS. 12A-12B it can be seen that the chemical change of the bimetallic is more like that of the precursor oxide. In this case, the material is too lossy, and does not heat well. Microwave sintering is a well-studied process using small metallic powders. This phenomenon, along with differential heating in radial volumes based on the penetration depth may lead to restructuring of the surface to leading to a smoother and less porous surface. The BET results indicate that surface area slowly increases due to repeated oxidation by nitrogen followed by reduction with hydrogen. The microwave may enhance the formation of unreactive phases near the surface, where the wave is at its strongest and at phase boundaries were Maxwell-Wagner polarization is at its strongest. This in turn leads to less site and higher activation barriers for N⁻³ ion diffusion into the crystal structure. Ultimately this process breaks the chemical looping cycle.

For the Fe samples, the deactivation process seems to be more linked to the sintering and agglomeration of small particles because the chemical state of the Fe particles is short lived. This observation indicates that the heating process is more linked to the penetration depth as the particle sizes grow. The particles become larger due to sintering and thus heat less efficiency as they take on more reflective character under irradiation.

The effect of penetration depth is detailed in FIG. 18 that shows a schematic diagram showing the effect of penetration depth in which “d” and “Dₚ” indicated in the figure is, respectively, particle diameter and penetration depth of microwave irradiation. Briefly, without wishing to be bound by a particular theory, it is believed that if the size of the particle is on the order of the penetration depth, then the entire particle becomes “skin” and heating is volumetric. However, if the particle is too small, the particle may become invisible to the irradiation, a problem possibly encountered with certain nanoparticle catalysts under microwave conditions. Finally, if the particle is too large the surface skin effect will reflect the radiation and heating will be non-uniform (R. R. Mishra and A. K. Sharma, Compos. Part Appl. Sci. Manuf., 2016, 81, 78-97), which may also occur if conductive particles share electrons forming a “super-particle” which may reflect incident radiation.

On the other hand, the CoMo bimetallic shows much less evidence of sintering, but as the material is completely changed from its metallic state to the “lossier” nitrided state the dielectric properties take on more of the original oxide character. This leads to a less efficient heating process, the tendency for the reaction not to run to completion or to deplete the CoMo samples supports this interpretation.

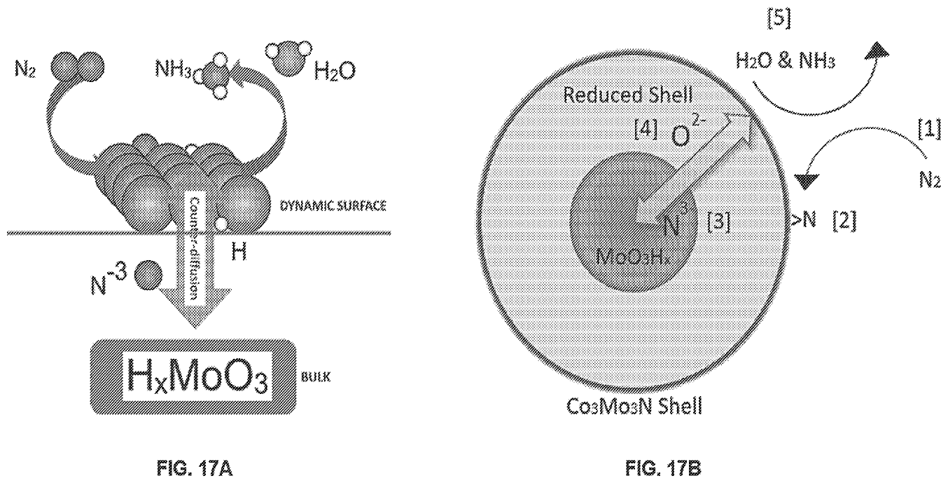

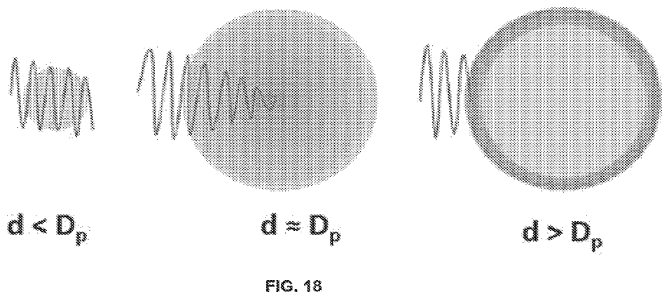

The illustration in FIG. 17A describes proposed mechanism explaining the observation of both ammonia and water synthesis occurring in a reduced CoMo bimetallic with no gaseous H₂ present. Without wishing to be bound by a particular theory, it is believed that the particle follows the shrinking core model of non-catalytic reacting gas-solid reacting particles originally published by Wen. This approximation does not entirely hold, as the Co₃Mo₃N surface is known to be an active catalyst for ammonia synthesis however at this level of consideration the model is appropriate and suggests the existence of an unreduced, or partially reduced core. FIG. 17B shows further proposed aspects of the reaction representing a dynamic surface and unreduced core. Without wishing to be bound by a particular theory, it is believed in step [1] in the figure that dinitrogen diffuses to the surface and dissociates; in step [2] in the figure that nitrogen begins to diffuse into the particle and a nitride shell forms; in step [3] in the figure that as nitrogen continues to diffuse inward, the crystal structure can stabilize, lose oxygen, and form a nitride compound and it is suspected that molybdenum bronzes, HₓMoO₃, play a role; in step [4] in the figure that hydroxyl ions begin to diffuse out as the Mo is oxidized by nitrogen; and in step [5] in the figure that hydroxides reach the surface where they encounter nitride ions, recombine, and diffuse away as both ammonia and water. Further, without wishing to be bound by a particular theory, it is possible that this phase transformation requires nitrogen in the bulk to facilitate the loss of oxygen.

Additional CLAS candidate materials and results are shown in Table 4 below.

TABLE 4

| Nitrogen Chemical | |
|---|---|
| Looping Candidate | Reaction Engineering Notes |
| Mo metal | Mo is not an ideal candidate for |
| | nitrogen chemical looping; however, it |
| | holds historical and scientific |
| | importance to nitrogen fixation. |
| MoO₂ | The low vapor pressure of MoO₃ |
| | causes some mass loss to reactor |
| | walls as a molybdenum film. The |
| | oxides do heat under microwave |
| | irradiation, but this effect decreases as |
| | the oxygen content is reduced. |
| Mn metal | Excellent candidate for nitrogen |
| | chemical looping as shown by the |
| | publication record, however, a distinct |
| | drawback is the massive loss of suffer |
| | area when metal particles sinter |
| | together during nitridation. |
| MnO₂ | The temperature required to fully |
| | reduce MnO₂ to Mn is above the range |
| | studied here, however, MnO still forms |
| | a limited nitride which can produce |
| | small amounts of ammonia. The Mn |
| | suboxide form can be easily observed |
| | by a pale green coloring and is easily |
| | re-oxidized. This material does not |
| | succumb to sintering like pure Mn |
| | metal does at ~700° C. |
| Co₃O₄ | Cobalt oxides reduce at a low |
| | temperature but retain very small |
| | amounts of nitrogen alone. |
| Mg metal | The melting point of metallic Mg is |
| | within the range of efficient nitride |
| | synthesis, ~650° C., making this a |
| | difficult material to work with alone. |
| 2.5% Co 2.5% Mo/γ- | Hydrodesulfurization catalyst shows |
| Al₂O₃ | some limited nitride formation despite |
| | low metal loading. |
| CoMoO₄ | Can be observed to heat in microwave |
| | reactor but this effect is limited to |
| | changing oxidation states and thus |
| | does not last and is not repeatable. |
| | Like MoO₂, temperature ramp rate can |
| | create metallic films which indicate |
| | loss of MoO₃. |
| MgFe₂O₄ | No ammonia detected. |
| La_{0.6}Sr_{0.4}FeMnO | No ammonia detected. |
| (LSFM) | |
| CoMoO₄ + SiC | |
| CoMoO₄ + SiO₂ | Did not heat in microwave reactor. |
| MoO₂ + SiC | |
| MoO₂ + SiO₂ | Did not heat in microwave reactor. |
| Mn + SiC | Did not heat in microwave reactor. |
| Mn + SiO₂ | Did not heat in microwave reactor. |
| MnO₂ + SiC | Did not heat in microwave reactor. |
| MnO₂ + SiO₂ | Did not heat in microwave reactor. |
| Mo + SiC | Did not heat in microwave reactor. |
| Mo + SiO₂ | Did not heat in microwave reactor. |
| Ta₂O₅ | No ammonia detected. Temperature |
| | required to reduce sample exceeded |
| | range in this study. |
| CoMoO₄:Al₂O₃ | Ground with mortar and pestle the 1:1 |
| | ratio and calcined at 550° C., this |
| | material did heat effectively in the |
| | microwave for at least one cycle. |
| | Rapidly deactivated and lost |
| | performance afterward. |
| 4% Ru 4% Cs/MgO | Model traditional catalyst used in this |
| | laboratory. |
| 1% K 1% Ru/γ-Al₂O₃ | Model traditional catalyst used in this |
| | laboratory. |
| C12A7 (electride) | Did not heat in microwave reactor. |
| SiO₂ | ‘Invisible’ to microwave heating. |
| | Separates catalyst particles to allow |
| | heating and reduce electron |
| | conduction in the mass when |
| | homogeneously mixed. |
| SiC | Efficient absorber of microwave |
| | energy used to heat nearby particles |
| | when homogenously mixed. |
| Al metal | The melting point of metallic Al is |
| | within the range of efficient nitride |
| | synthesis, ~650° C., also making this a |
| | difficult material to work with alone. |
| Ti metal | No ammonia detected. |
| TiMn₂ | No ammonia detected. |
| γ-Al₂O₃ | Support for 2.5% Co 2.5% Mo/γ- |
| | Al₂O₃, no ammonia detected. |
| MgO | No ammonia detected. |

The data herein compare chemical looping ammonia synthesis materials subjected to three chemical cycles to evaluate respective productivity under both microwave and traditional thermal heating. The foregoing examples compare microwave heating on an equal basis as traditional thermal heating and found to outperform it on the first of the time on stream experiments under CLAS conditions.

The disclosure herein suggests that while the dielectric properties of microwave catalyst samples are important and critical to how materials interact with electromagnetic radiation, the penetration depth may be a more important factor for considering microwave matter interaction in microwave-enhanced catalysis. The present disclosure provides methods and compositions that can be tuned by varying the dielectric property to fall into an optimal lossy region, with a penetration depth which avoids surface only heating, or reflection and avoids on too-small scales, transparency to microwave radiation. In addition, the disclosed methods and compositions may be utilized with re-oxidation as a useful regeneration strategy depending on the starting material composition and morphology.

In various aspects, the disclosed CLAS processes using microwave energy provides advantages over conventional thermal fixed bed reactors that include both higher productivity and more operational flexibility. These features matched with microwave sensitive catalyst design can provide processes for decentralized ammonia production.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A method for synthesis of a nitrided catalyst composition, the method comprising:
providing a reaction chamber;
providing a catalyst composition in the reaction chamber;
flowing a reactant gas into the reaction chamber and over the catalyst composition;
wherein the reactant gas in contact with the catalyst composition forms a reaction composition;
wherein the reactant gas comprises nitrogen;
eating the reaction chamber;
wherein the heating is carried out at a nitridation reaction pressure of from about 0.5 atm to about 5 atm;
thereby synthesizing the nitrided catalyst composition.

2.-4. (canceled)

5. The method of claim 1, wherein the catalyst composition comprises Mn, Fe, Co—Mo, or combinations thereof.

6.-7. (canceled)

8. The method of claim 5, wherein the catalyst composition comprises Co—Mo.

9. The method of claim 1, wherein the nitridation reaction pressure is from about 0.9 atm to about 1.1 atm.

10. The method of claim 1, further comprising a microwave energy sorbent composition mixed with the catalyst composition, thereby forming a catalyst-microwave energy sorbent composition.

11. The method of claim 10, wherein the microwave energy sorbent composition comprises SiC.

12. The method of claim 1, further comprising an insulating microwave energy sorbent composition mixed with the catalyst composition, thereby forming an insulating catalyst-microwave energy sorbent composition.

13. The method of claim 12, wherein the insulating microwave energy sorbent composition comprises SiC.

14. The method of claim 10, wherein the microwave energy sorbent composition is selected from a metal, a metal salt, metal oxide, a metal sulfide, a metal carbide, a metal nitride, a hydrated salt, a ceramic material, a carbon material, a clay, a silicate, a zeolite, a silica, an alumina, a titania gel, a vermiculate, an attapulgite, a molecular sieve, water, and combinations of the foregoing.

15. The method of claim 14, wherein the microwave energy sorbent composition is selected from Ag₂S, CuS, MoS₃, PbS, ZnS, FeS, FeS₂, MoS₃, PbS, ZnS, CuO, NiO, Fe₃O₄, Co₂O₃, BaTiO₃, SiC, W₂C, B₄C, TiN, NiCl₂·6H₂O, Al₂(SO₄)₃·18H₂O, a SiOC ceramic, a ZrBr₂ ceramic, graphite, carbon fibers, carbon nanotubes, carbon black, a sepiolite clay, water, and combinations of the foregoing.

16. The method of claim 10, wherein the microwave energy sorbent composition and the catalyst composition are homogeneously distributed in the catalyst-insulator composition.

17. The method of claim 1, wherein the heating comprises thermally heating the reaction chamber using a heat source, irradiation of the reaction chamber with microwave energy, or a combination thereof.

18. The method of claim 17, wherein the heating comprises irradiation of the reaction chamber with microwave energy.

19. The method of claim 18, wherein the heating provides a temperature of from about 400° C. to about 1000° C. in the reaction chamber, in the catalyst composition, in the reactant gas, in the reaction composition, or combination thereof.

20. The method of claim 17, wherein the heating comprises thermally heating the reaction chamber using a heat source.

21. The method of claim 20, wherein the heating provides a temperature of from about 400° C. to about 1000° C. in the reaction chamber, in the catalyst composition, in the reactant gas, in the reaction composition, or combination thereof.

22. The method of claim 17, wherein the heating comprises irradiation of the reaction chamber with microwave energy and thermally heating the reaction chamber using a heat source.

23.-32. (canceled)

33. A nitrided catalyst composition prepared by the method of claim 1.

34. A method for synthesis of ammonia, the method comprising:
providing a reaction chamber;
providing the nitrided catalyst composition of claim 33;
flowing a reactant gas into the reaction chamber and over a catalyst composition;
wherein the reactant gas comprises hydrogen;
wherein reactant gas in contact with the catalyst composition forms an ammonia reaction composition;
heating the reaction chamber;
thereby sythesizing ammonia.

35.-45. (canceled)

46. Ammonia prepared by the method of claim 34.

47. A method for synthesis of ammonia, the method comprising:
providing a reaction chamber;
providing a catalyst composition in the reaction chamber;
flowing a first reactant gas into the reaction chamber and over the catalyst composition;
wherein the reactant gas in contact with the catalyst composition forms a reaction composition;
wherein the reactant gas comprises nitrogen;
heating the reaction chamber in a first heat step;
wherein the heating is carried out at a nitridation reaction pressure of from about 0.5 atm to about 5 atm;
thereby synthesizing a nitrided catalyst composition;
purging the reaction chamber with a gas;
flowing a second reactant gas into the reaction chamber and over the nitrided catalyst composition;
wherein the reactant gas comprises hydrogen; and
wherein the reactant gas in contact with the catalyst composition forms an ammonia reaction composition;
heating the reaction chamber in a second heating step;
thereby synthesizing ammonia.

48.-83. (canceled)
